(19) United States
(12) Patent Application Publication
(10) Pub. No.: US 2012/0283407 A1
(43) Pub. Date: Nov. 8, 2012

(54) New polyamide, polyimide or polyamide-imide comprising dibenzodiazocine units

(75) Inventor: Charles R. Hoppin, Alpharetta, GA (US)

(73) Assignee: SOLVAY SPECIALTY POLYMERS USA, LLC, Alpharetta, GA (US)

(21) Appl. No.: 13/517,233

(22) PCT Filed: Dec. 17, 2010
(86) PCT No.: PCT/EP2010/070030

§ 371 Date: Jun. 19, 2012

Related U.S. Application Data
(60) Provisional application No. 61/288,948, filed on Dec. 22, 2009.

(51) Int. Cl. C08G 69/32; C08G 69/12; C08G 75/20

(52) U.S. Cl. 528/337; 528/348; 528/342

(57) ABSTRACT

The invention relates to polymers (P) of amides, imides, amides-imides or their derivates. The polymer (P) comprising recurring units (I) of one or more structural formula(e): -A-B-C-D- (I), wherein, A and C, identical or different from each other and from one structural formula to another, independently represent an amido group an imido group of formula or a mixture thereof; B, identical or different from one structural formula to another, is independently selected from the set consisting of C₄-C₅₀ hydrocarbon groups, C₁₂-C₅₀ groups, a dibenzodiazocine-containing divalent group, and a mixture thereof; D, identical or different from one structural formula to another, independently represents a dibenzodiazocine-containing divalent group. The invention also relates to a process for the preparation of said polymers. Moreover, the invention relates to polymer compositions containing said polymer, its shaped articles or shaped parts as well as applications of those polymers. On other aspect, the present invention relates to new monomers containing at least one dibenzodiazocine.

### CROSS-REFERENCE TO RELATED APPLICATIONS

This application is a U.S. national stage entry under 35 U.S.C. §371 of International Application No. PCT/EP2010/070030 filed Dec. 17, 2010, which claims priority to U.S. provisional application No. 61/288,948 filed Dec. 22, 2009, the whole content of which being incorporated herein by reference for all purposes.

### FIELD OF THE INVENTION

The present invention relates to polymers of amides, imides, amides-imides or their derivates, which contain at least one dibenzodiazocine recurring unit. The invention also relates to a process for the preparation of said polymers, as well as to applications of those polymers.

### DESCRIPTION OF THE RELATED ART

Polymers containing either or both the following dibenzodiazocine recurring units

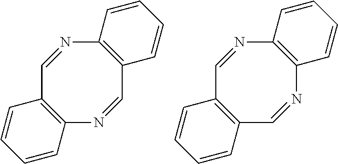

have been recently described in document US-A-2006/0058499 as well as in a patent application assigned to Solvay Advanced Polymers (WO 2009/101064A1), the whole content of which is incorporated herein by reference.

Polymers that include C═N bonds in their structures, such as polyazomethines, polyquinolines, polyketimines (polyketanils), and others are well known, which is discussed by A. Iwan, D. Sek in Progress in Polym. Sci., 33, 289-345(2008), the whole content of which is incorporated herein by reference. These polymers generally possess high thermal stability, excellent mechanical strength and tunable optoelectronic properties, which is also discussed by A. Iwan, D. Sek. The C═N bond can also coordinate with metals so that these polymers can serve as catalyst carriers. Potential applications include sensors, light-emitting diodes, high-temperature structural parts for aerospace, and separation membranes.

Research and development work conducted on these dibenzodiazocine polymers have revealed however that they are some what deficient in a number of properties, for example, thermal properties and flame resistance.

The present invention aims to overcome these disadvantages by providing new polymer materials comprising dibenzodiazocine-based recurring units and amides, imides or amides-imides recurring units, while, in the same time, improving at least one of the properties of each of their polymeric constituents, selected among glass transition temperature, thermal stability, flame resistance, chemical resistance and melt processability, preferably more than one of these properties; still more preferably, these new polymeric compositions feature an improved balance of all of these properties.

### SUMMARY OF THE INVENTION

In one aspect, the present invention is directed to polymers (P) comprising recurring units (I) of one or more structural formula(e):

-A-B-C-D- (I)

wherein:
A and C, identical or different from each other and from one structural formula to another, independently represent an amido group of formula

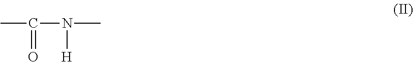

an imido group of formula

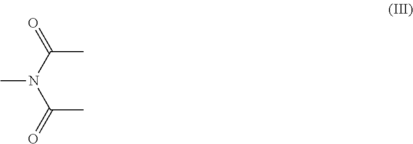

or mixtures thereof,
B, identical or different from one structural formula to another, is independently selected from the set consisting of

C₄-C₅₀ hydrocarbon groups

C₁₂-C₅₀ groups of the general formulae:

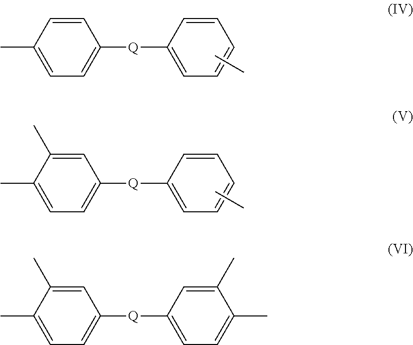

wherein, in formulae (IV) and (V), the unassigned positioned isomer is either meta or para to Q, and Q is a C₀-C₃₈ divalent group containing at least one heteroatom,

a dibenzodiazocine-containing divalent group,

and mixtures thereof,
D, identical or different from one structural formula to another, independently represents a dibenzodiazocine-containing divalent group.

In another aspect, the present invention is directed to a method for preparing polymers comprising dibenzodiazocine group(s), for example, the above described polymers, which comprises reacting in a polycondensation reaction at least one set of the following four sets of monomers (S1), (S2), (S3) and (S4):

### Set (S1)

at least one monomer (M1) of general formula X-D-X, and

at least one monomer (M2) of general formula Y—B—Y,

### Set (S2)

at least one monomer (M3) of general formula X—B—X, and

at least one monomer (M4) of general formula Y-D-Y,

### Set (S3)

the monomers X-D-Y (M5) and X—B—Y (M6),

### Set (S4)

X-D-Y (M5)

wherein:
B, identical or different from one structural formula to another, is independently selected from the set consisting of

C₄-C₅₀ hydrocarbon groups

C₁₂-C₅₀ groups of the general formulae:

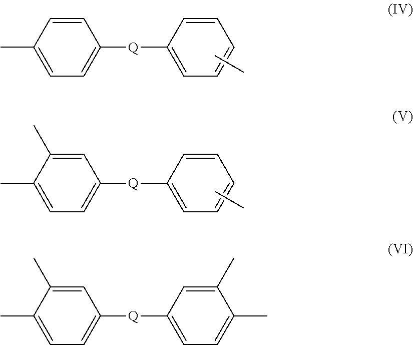

wherein, in formulae (IV) and (V), the unassigned positioned isomer is either meta or para to Q, and Q is a C₀-C₃₈ divalent group containing at least one heteroatom,

a dibenzodiazocine-containing divalent group,

and mixtures thereof,
D, identical or different from one structural formula to another, independently represents a dibenzodiazocine-containing divalent group,
X independently represents amino,
Y, identical or different from each other and from one monomer to another, independently represents carboxyl or anhydride group, or a mixture thereof.

Polymer compositions containing at least one polymer chosen among the above polymers, the polymers prepared by the method as above are another aspect of the invention.

Shaped articles or shaped parts of article containing at least one polymer composition chosen among the above polymer compositions, or at least one polymer as above or the polymers prepared by the method as above and the above polymers also are objects of the invention.

The invention also relates to a new monomer having a general formula: G-D-G, in which, D represents at least one dibenzodiazocine-containing divalent residue, G represents reactive radical. Moreover, the invention relates to a polymer which is preparable by polymerizing the above monomer, and to a method for preparing a polymer which comprises polymerizing the above monomer.

### DETAILED DESCRIPTION OF THE INVENTION

The present invention relates to polymers of amides, imides, amides-imides or their derivates, which contain at least one dibenzodiazocine recurring unit. The invention also relates to a process for the preparation of said polymers. Moreover, the invention relates to polymer compositions containing said polymer, its shaped articles or shaped parts as well as applications of those polymers. On other aspect, the present invention relates to new monomers containing at least one dibenzodiazocine.

### Polymers

In main aspect, the polymers of the present invention comprise recurring units (I) of one or more structural formula(e) -A-B-C-D- (I), in which A, B, C and D are defined as above.

In one embodiment, the recurring units of polymer are a mixture of recurring units of at least two structural formulae -A-B-C-D-.

### Recurring Unit A and C

A and C, identical or different from each other and from one structural formula to another, independently represent an amido group of formula

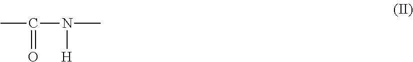

an imido group of formula

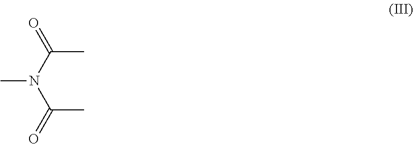

or a mixture thereof.

### Recurring Unit B

B, identical or different from one structural formula to another, is independently selected from the set consisting of

C₄-C₅₀ hydrocarbon groups

C₁₂-C₅₀ groups of the general formulae:

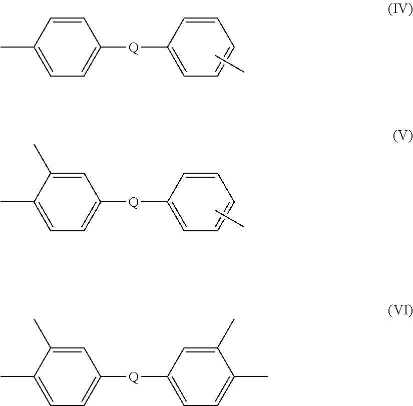

wherein, in formulae (IV) and (V), the unassigned positioned isomer is either meta or para to Q, and Q is a C₀-C₃₈ divalent group containing at least one heteroatom,

a dibenzodiazocine-containing divalent group,

and mixtures thereof.

In one embodiment, said C₄-C₅₀ hydrocarbon groups are arylenes, trivalent groups of aromatic hydrocarbons or tetravalent groups of aromatic hydrocarbons.

In another embodiment, Q is oxygen, carbonyl, halogenated C₁-C₃₈ alkylene, C₁-C₃₈ divalent hydrocarbon group interrupted by at least one heteroatom O.

In accordance with the present invention, said C₄-C₅₀ hydrocarbon groups may be notably preferably are selected among at least one of the group consisting of p-phenylene, m-phenylene, o-phenylene, 1,4-naphthylene, 1,4-phenanthrylene and 2,7-phenanthrylene, 1,4-anthrylene and 9,10-anthrylene, 2,7-pyrenylene, 1,6-coronenylene, 2,6-naphthylene, 2,6-anthrylene, 1,3-phenylene, 1,3- and 1,6-naphthylenes, 1,2,3-benzenetriyl, 1,2,4-benzenetriyl, 1,3,4-benzenetriyl, 1,3,5-benzenetriyl, 1,2,3,5-benzenetetrayl, 1,2,4,5-benzenetetrayl,

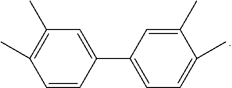

In accordance with the present invention, said C₁₂-C₅₀ groups may be notably preferably are selected among at least one of the group consisting of

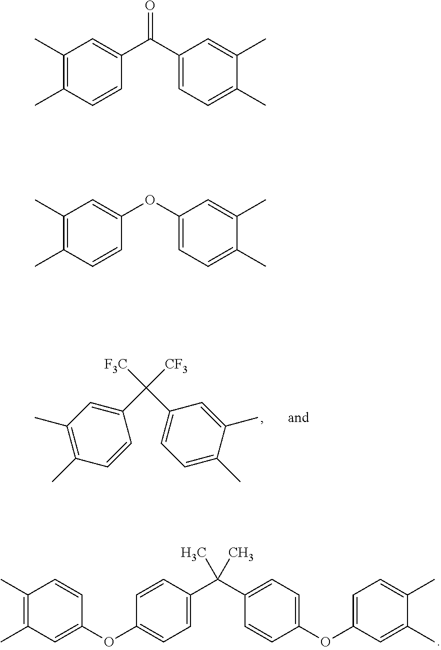

In alternative embodiment, said dibenzodiazocine-containing divalent group(s) B denotes generally any divalent group comprising one or more units selected from:

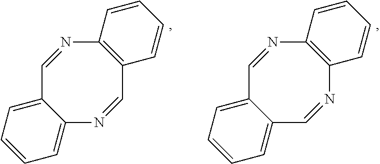

the homologous of the above two units substituted by at least one substituting group, and mixtures thereof.

In accordance with the present invention, the dibenzodiazocine-containing divalent group(s) B may be notably preferably selected among at least one of the groups having the structure indicated by the following formulae:

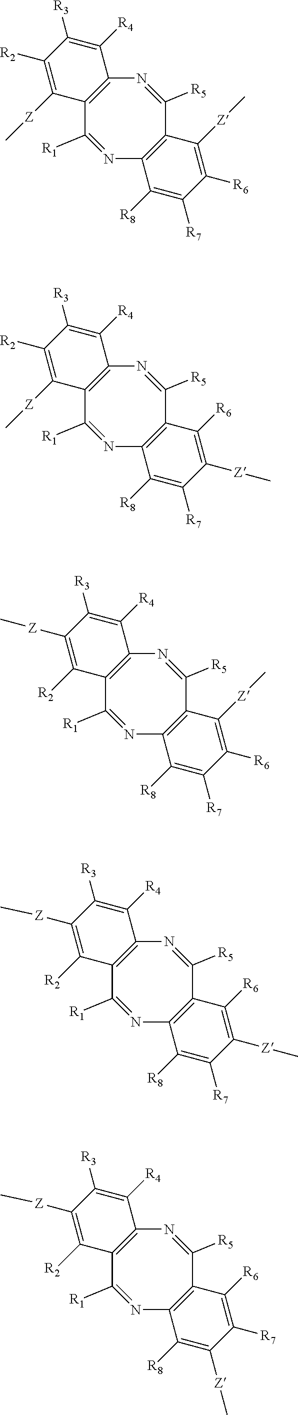

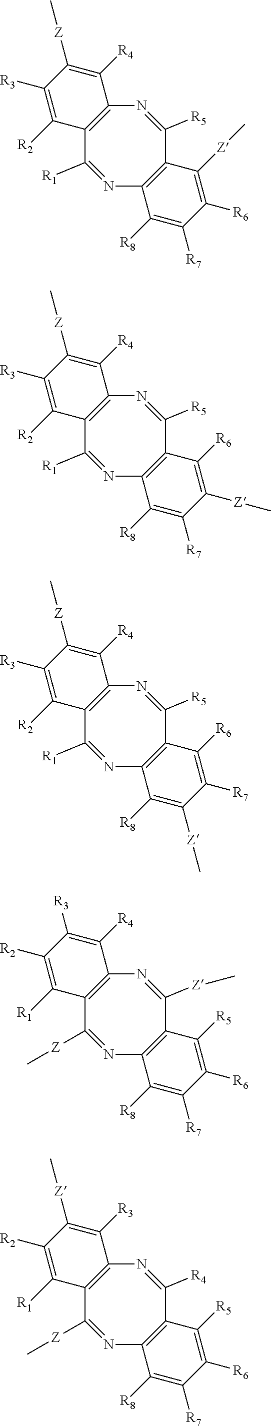

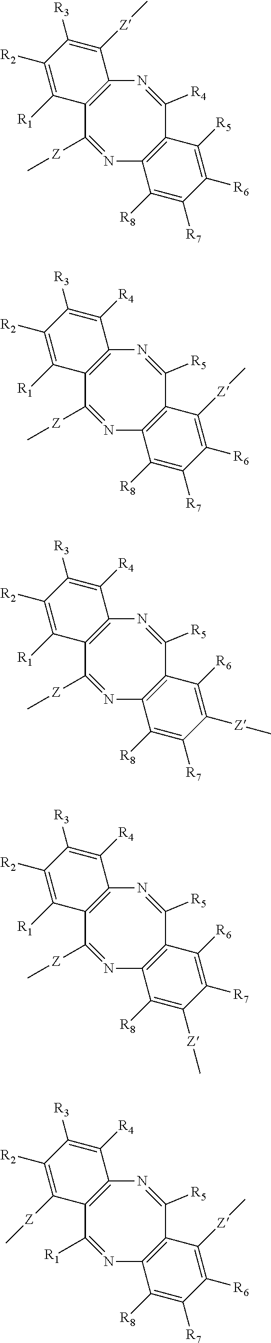

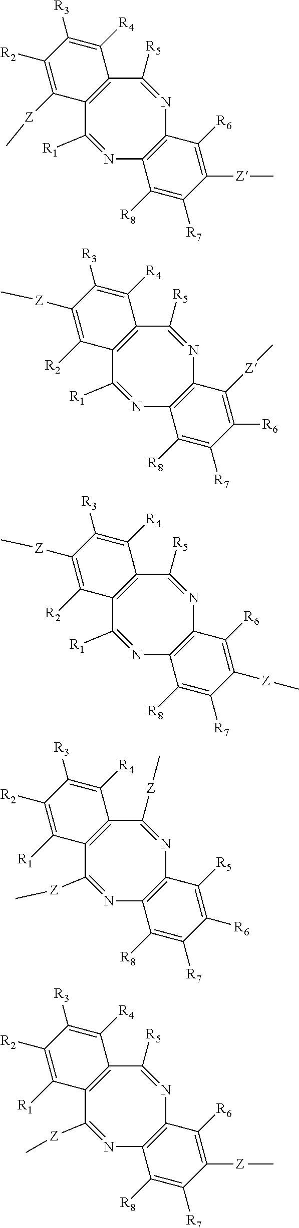

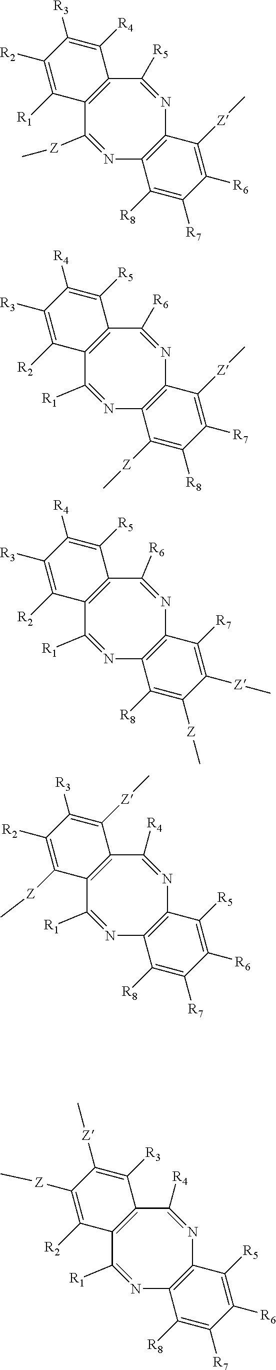

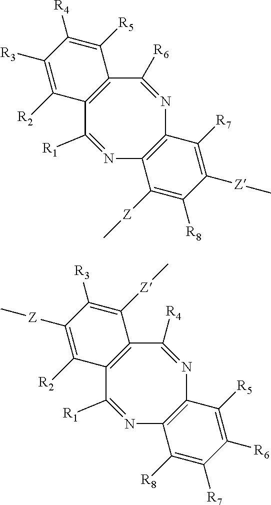

and mixtures thereof.

In accordance with the present invention, the preferred examples of R₁-R₈, Z and Z′ independently are as follows:
R₁-R₈ are independently selected from the group consisting of H, alkyl, substituted alkyl, aryl, substituted aryl, heteroaryl, substituted heteroaryl, halogen, —CN, —CHO, —CORₐ, —CRₐ═NR_{b}, —ORₐ, —SRₐ, —SO₂Rₐ, —PORₐR_{b}, —PO₃Rₐ, —OCORₐ, CO₂Rₐ, —NRₐR_{b}, —N═CRₐR_{b}, —NRₐCOR_{b}, —CONRₐR_{b} in which Rₐ and R_{b} are independently selected from the group consisting of H, alkyl, substituted alkyl, aryl, substituted aryl, heteroaryl, and substituted heteroaryl, and two or more of R₁-R₈, Rₐ, and R_{b} may or may not be linked to form a ring structure,
Z and Z′, independently represent unsubstituted or substituted divalent group, a direct bond or a mixture thereof.

In another embodiment, Z and Z′, independently are chosen from substituted or unsubstitued aryleneoxyarylene.

Even particularly, in another embodiment, Z and Z′, independently represent 4,4′-phenyleneoxyphenylene or 4,3′-phenyleneoxyphenylene. Among all these possible dibenzodiazocine-containing divalent groups of B,

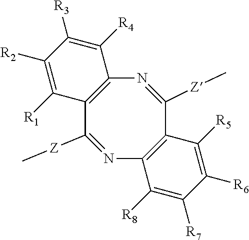

is preferred, the substituents R₁ to R₈ linked to the benzo rings are H are very preferred, essentially for reasons of accessibility. Further, Z and Z′, independently are chosen from aryleneoxyarylene.

Also, among these preferred dibenzodiazocine-containing divalent groups including Z and Z′, those where Z and Z′ are 4,4′-phenyleneoxyphenylene or 4,3′-phenyleneoxyphenylene are also very preferred.

The group B of the following formula:

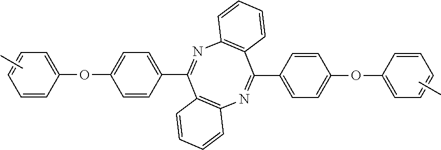

is especially preferred, wherein, the unassigned positioned isomers are, independently from each other, either meta or para to O (possibly, both are either meta or para to O; alternatively, one is meta to O and the other one is para to O).

### Recurring Unit D

D, identical or different from one structural formula to another, independently represents a dibenzodiazocine-containing divalent group. In alternative embodiment, said dibenzodiazocine-containing divalent group(s) D denotes generally any divalent group comprising one or more units selected from:

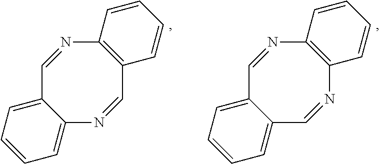

the homologous of the above two units substituted by at least one substituting group, and mixtures thereof.

In accordance with the present invention, the dibenzodiazocine-containing divalent group(s) D may be notably selected among at least one of the groups having the structure indicated by the following formulae:

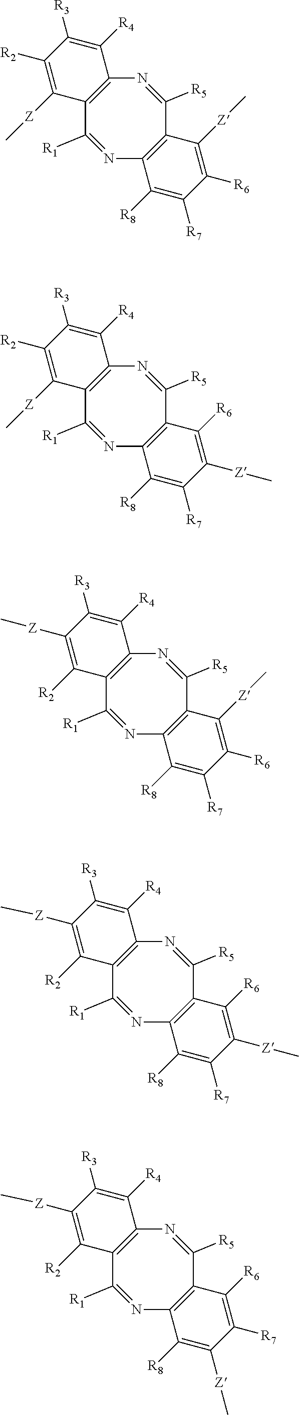

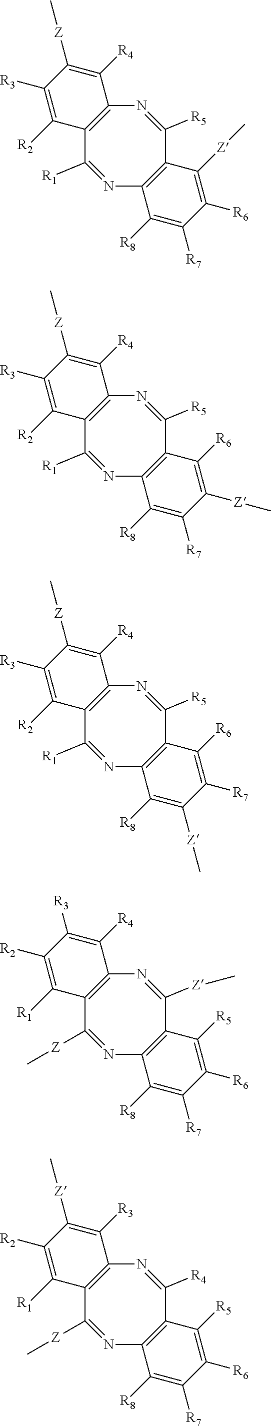

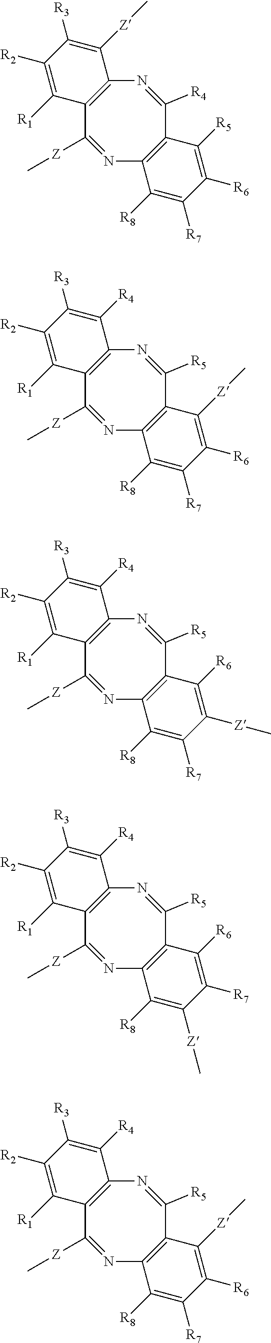

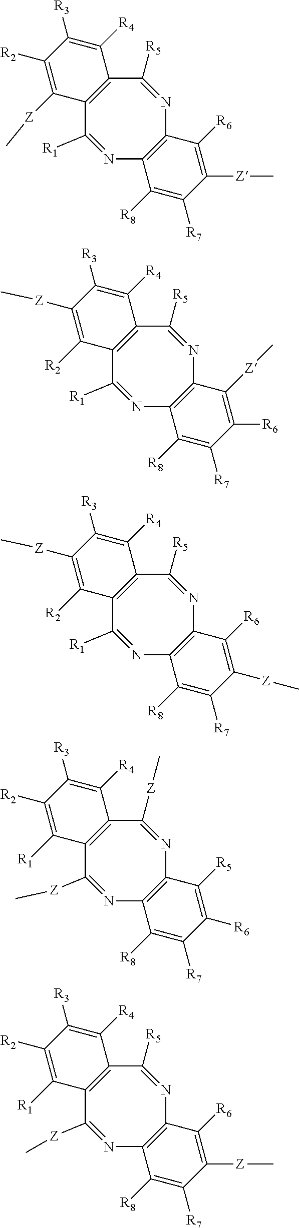

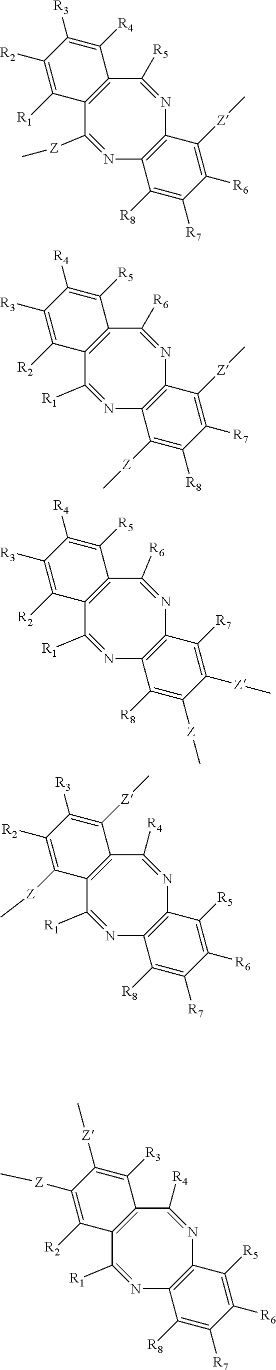

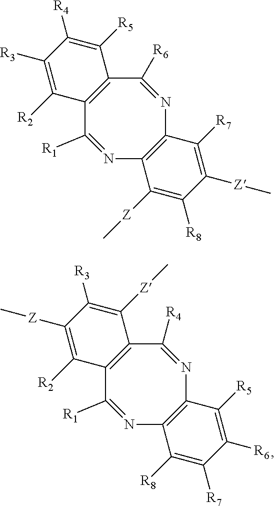

and mixtures thereof.

In accordance with the present invention, the preferred examples of R₁-R₈, Z and Z′ independently are as follows:
R₁-R₈ are selected from the group consisting of H, alkyl, substituted alkyl, aryl, substituted aryl, heteroaryl, substituted heteroaryl, halogen, —CN, —CHO, —CORₐ, —CRₐ═NR_{b}, —ORₐ, —SRₐ, —SO₂Rₐ, —PORₐR_{b}, —PO₃Rₐ, —OCORₐ, —CO₂Rₐ, —NRₐR_{b}, —N═CRₐR_{b}, —NRₐCOR_{b}, —CONRₐR_{b} in which Rₐ and R_{b} are independently selected from the group consisting of H, alkyl, substituted alkyl, aryl, substituted aryl, heteroaryl, and substituted heteroaryl, and two or more of R₁-R₈, Rₐ, and R_{b} may or may not be linked to form a ring structure,
Z and Z′, independently represent unsubstituted or substituted divalent group, a direct bond or a mixture thereof.

In the present invention, the “halogen” represents fluorine, chlorine, bromine or iodine.

In another embodiment, Z and Z′, independently are chosen from substituted or unsubstitued aryleneoxyarylene.

Even particularly, in another embodiment, Z and Z′, independently represent 4,4′-phenyleneoxyphenylene or 4,3′-phenyleneoxyphenylene. Among all these possible dibenzodiazocine-containing divalent groups D,

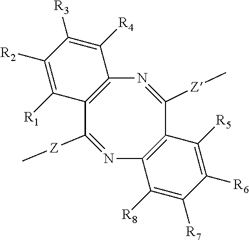

is preferred, the substituents R₁ to R₈ linked to the benzo rings are H are very preferred, essentially for reasons of accessibility. Further, Z and Z′, independently are chosen from aryleneoxyarylene.

Also, among these preferred dibenzodiazocine-containing divalent groups including Z and Z′, those where Z and Z′ are 4,4′-phenyleneoxyphenylene or 4,3′-phenyleneoxyphenylene are also very preferred.

The group D of the following formula:

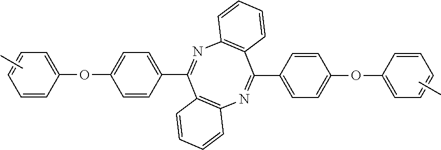

is especially preferred, wherein, the unassigned positioned isomers are, independently from each other, either meta or para to O (possibly, both are either meta or para to O; alternatively, one is meta to O and the other one is para to O).

### Recurring Units (I)

In one embodiment, the polymer (P) include, but not limit to, the recurring units (I) having at least one structural fomula(e):

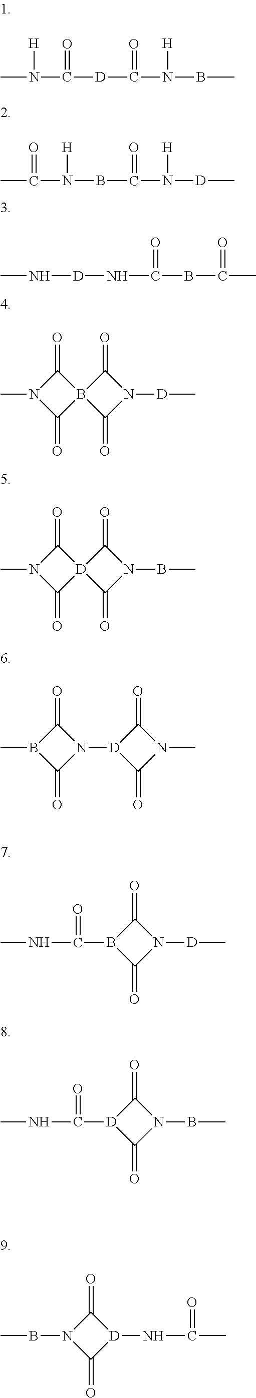

In one embodiment, the recurring units are a mixture of recurring units of at least two structural formulae -A-B-C-D- as defined above.

In one embodiment, in the recurring units of polymer (P), B is identical to D.

Polymers provided in accordance with the present invention generally feature glass transition temperatures (T_{g}) (conventionally measured by differential scanning calorimetry, DSC) higher than 200° C., preferably higher than 215° C. and which can even exceed 245° C. The weight average molecular weight (M_{w}) (conventionally measured by gas permeation chromatography, GPC (relative to polystyrene standards)) of the polymers is generally higher than 5×10³, preferably higher than 10×10³, and more preferably higher than 20×10³. This weight average molecular weight (M_{w}) is generally lower than 10000×10³, preferably lower than 100×10³, and more preferably lower than 60×10³. The number average molecular weight (Mₙ) (conventionally measured by selective elution chromatography, SEC with the end group analysis using the integrations from the ¹H-NMR spectrum) of the polymers is generally is generally higher than 3×10³, preferably higher than 7×10³, even higher than 10×10³, and more preferably higher than 20×10³. This number average molecular weight (Mₙ) is generally lower than 5000×10³, even lower than 1000×10³, preferably lower than 70×10³, more preferably lower than 50×10³.

As to the overall structure, polymers in accordance with the invention may be linear, branched, hyperbranched, dendritic, random, block or any combinations thereof.

Indeed, the outstanding balance of advantageous properties featured by the inventive polymers (P) in connection with their high glass transition temperature, thermal stability, flame resistance, chemical resistance and melt processability, makes them particularly suitable for the manufacture, by any known processing method, of devices such as radios, television sets and computers and electrical wiring coating. Furthermore, the polymers of the present invention can be used as dielectrics in various electronic and optoelectronic applications including but not limited to printing wiring boards, semiconductors, and flexible circuitry. Additionally, the polymers (P) can be used in various electronic adhesive applications including but not limited to lead-frame adhesives and also in aircraft interior applications. Other applications of the polymers (P) in accordance with the invention comprise electromechanical actuating devices; medical devices; sensing devices; applications requiring use temperature up to 200° C., even up to 250° C. and more; free-standing films; fibers; foams; medical implements, nonwoven fibrous materials; separation membranes (such as gas separation membranes), semi-permeable membranes; ion exchange membranes; fuel cell devices; photoluminescent or electroluminescent devices, etc.

### Method for Preparing Polymers

In another aspect, the invention is an object of a method for preparing a polymer comprising dibenzodiazocine group(s), which comprises reacting the following monomers in a polycondensation reaction:

at least one monomer (M1) of general formula X-D-X, and

at least one monomer (M2) of general formula Y—B—Y, and/or

at least one monomer (M3) of general formula X—B—X, and

at least one monomer (M4) of general formula Y-D-Y, and/or

the monomers X-D-Y (M5) and X—B—Y (M6), and/or

X-D-Y (M5)

wherein:
B, identical or different from one structural formula to another, is independently selected from the set consisting of

C₄-C₅₀ hydrocarbon groups

C₁₂-C₅₀ groups of the general formulae:

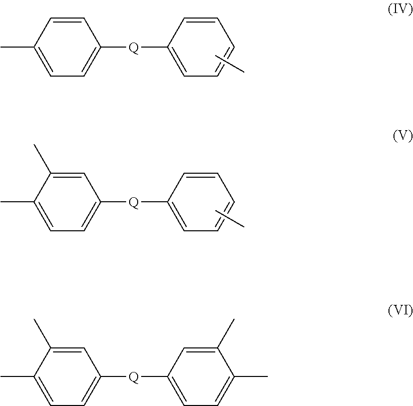

wherein, in formulae (IV) and (V), the unassigned positioned isomer is either meta or para to Q, and Q is a C₀-C₃₈ divalent group containing at least one heteroatom,

a dibenzodiazocine-containing divalent group,

and a mixture thereof,
D, identical or different from one structural formula to another, independently represents a dibenzodiazocine-containing divalent group,
X independently represents amino,
Y, identical or different from each other and from one monomer to another, independently represents carboxyl or anhydride group, or a mixture thereof.

In one embodiment, Y—B(or D)-Y and X—B(or D)-Y are as follows:

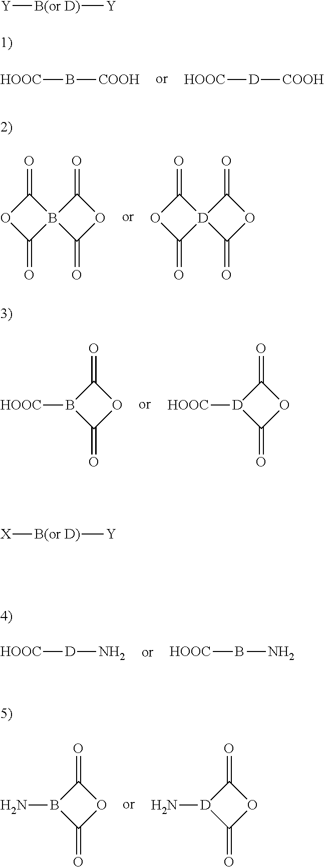

Furthermore, in the description of the present invention, more preferably, the definitions of the groups B and D in the present monomer are the same as the above definitions in the polymers.

More particularly, the above method is used to preparing the polymer of the present invention as defined above.

The general conditions under which the monomers have to be contacted to achieve the polymerization involving the necessary reactions are not critical and their principles well known in the art of condensation polymerization processes. The monomers may be contacted together in any order. They are generally mixed together in an organic liquid medium, which most often contain a solvent selected among tetrahydrofurane, (THF), N,N-dimethylformamide (DMF), N-methyl-2-pyrrolidone (NMP), N,N-dimethylacetamide (DMAc), N-methyl-2-pyrrolidone, diphenylsulfone, pyridine, toluene, methones (Ac₂O), xylene, salicylic acid, water and the like. The polymerization can be carried out under catalyses, for example, isoquinoline, TsOH and all catalyses used in the polycondensation reaction, which are known by the one skilled in the art. The polymerization temperature is generally higher than 80° C., preferably higher than 120° C. The polymerization is generally carried out for a duration exceeding one hour, and the duration of the polymerization may exceed 10 hours.

The respective amounts of monomers are selected, taking their respective reactivity into account, for instance by some preliminary tests, in order to obtain desired final polymers. It is preferred to control stoechiometrically the composition ratio of the D groups with the feed ratio of the corresponding monomer.

The polymers may be advantageous end-capped by adding an end-capping agent to the polymerization mixture. Non limitative examples of suitable end-capping agents are t-butylphenol and 4-hydroxybiphenyl.

### Polymer Compositions of the Present Invention

Still another aspect of the present invention concerns polymer compositions containing at least one polymer chosen among the polymers (P) as above described and the polymers prepared by the method as above described, and one or more ingredient(s) other than said at least one polymer.

Said other ingredient(s) can be selected notably among conventional ingredients of poly(aryl ether sulfone)s and/or poly(aryl ether ketone)s compositions, include light stabilizers (e.g., 2-hydroxybenzophenones, 2-hydroxyphenylbenzotriazoles, hindered amines, salicylates, cinnamate derivatives, resorcinol monobenzoates, oxanilides, p-hydroxybenzoates, and the like); plasticizers (e.g. phthalates, and the like); dyes, colorants, organic pigments, inorganic pigments (e.g., TiO₂, carbon black and the like); flame retardants (e.g., aluminum hydroxide, antimony oxides, boron compounds, bromine compounds, chlorine compounds, and the like); antistatic additives; biostabilizers; blowing agents; adhesion promoters; compatibilizers; curing agents; lubricants; mold release agents; smoke-suppressing agents; heat stabilizers; antioxidants; UV absorbers; tougheners such as rubbers; anti-static agents; acid scavengers (e.g., MgO and the like); melt viscosity depressants (e.g., liquid crystalline polymers, and the like); processing aids; anti-static agents; extenders; reinforcing agents, fillers, fibrous fillers such as glass fibers and carbon fibers, acicular fillers such as wollastonite, platty fillers, particulate fillers and nucleating agents such as talc, mica, titanium dioxide, kaolin and the like, and mixtures thereof.

Additionally, it is envisioned, within the scope of the invention, to blend include in the presently invented compositions engineering polymers other than polymers (P), notably: poly(aryl ether sulfone)s like poly(biphenyl ether sulfone)s, poly(ether sulfone)s and bisphenol A polysulfones; poly(aryl ether ketone)s like poly(ether ether ketone)s, poly(ether ketone)s and poly(ether ketone ketone)s; polyetherimides (e.g., ULTEM®-type and AURUM®-type polymers); polyamideimides (e.g., TORLON®-type polymers), polyphenylenes (e.g., PRIMOSPIRE™), polyimides, polyamides such as polyphthalamides, polyesters, polycarbonates such as bisphenol A polycarbonates, polyureas, liquid crystalline polymers, polyolefins, styrenics, polyvinylchloride, phenolics, polyethylene terephthalates, acrylics and the like.

The weight of said optional ingredient(s), based on the total weight of the invented polymer compositions, may be of at least 1%, 2%, 5%, 10%, 20%, 30%, 40%, 50% or even more. On the other hand, it may be of at most 50%, 40%, 30%, 20%, 10%, 5%, 2% or 1%. Good results were obtained when the invented polymer compositions consisted essentially of, or even consisted of, the polymers (P). Good results can also be obtained with fiber-filled polymer compositions comprising at least one polymer chosen among the polymers (P) as above described and the polymers (P) prepared by the method as above described, and one or more fibrous fillers, wherein the weight amount of fibrous filler, based on the total weight of the polymer composition, ranges usually from 5 wt. % to 30 wt. %.

The invented polymer compositions are advantageously prepared by any conventional mixing method. A certain method comprises dry mixing the ingredients of the invented polymer compositions of concern in powder or granular form, using e.g. a mechanical blender, then extruding the mixture into strands and chopping the strands into pellets.

### Shaped Articles and Shaped Parts of Articles of the Present Invention

Still another aspect of the present invention concerns shaped articles or shaped parts of articles containing either the polymer compositions as above described, or at least one polymer chosen among the polymers (P) as above described and the polymers (P) prepared by the method as above described.

### Monomers

Still another aspect of the present invention relates to new monomers, which have having a general formula: G-D-G, in which:
D represents a dibenzodiazocine-containing divalent group. Preferably, said D have the same definition as the above;
G, identical or different from each other, independently represents reactive radical chosen from the group consisting of hydroxyl, halogen, carboxyl, nitro, amino, anhydride group, and cyano, with the condition that:
when G represents hydroxyl, halogen or nitro, Z and Z′ indicated in the group D (please see the above), identical or different from each other, represent aryleneoxyarylene.

In accordance with the present invention, the D may be more preferably of the structural formula:

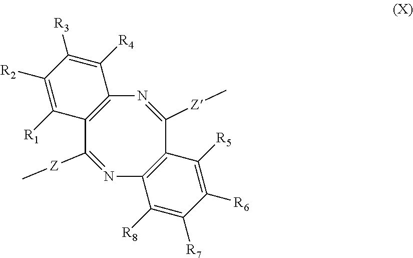

wherein Z and Z′, identical or different from each other, represents aryleneoxyarylene,
G, identical or different from each other, independently represents reactive radical chosen from the group consisting of carboxyl, amino anhydride group. In one particularly preferred embodiment, in the formula (X), Z and Z′, independently represent 4,4′-phenyleneoxyphenylene or 4,3′-phenyleneoxyphenylene.

Certainly, polymers preparable by polymerizing the above monomer(s) are also one part of the present invention.

### MODES FOR CARRYING OUT THE INVENTION

Hereinafter, the present invention is described in considerable detail. The following examples are offered by way of illustration to help those skilled in the art understand the present invention, and are not intended to limit the scope of the invention.

### Synthesis of Monomers

Two new diaminodiazocines, D-1 (from 4-aminophenol) and D-2 (from 3-aminophenol) were prepared in two steps as shown in Scheme 1:

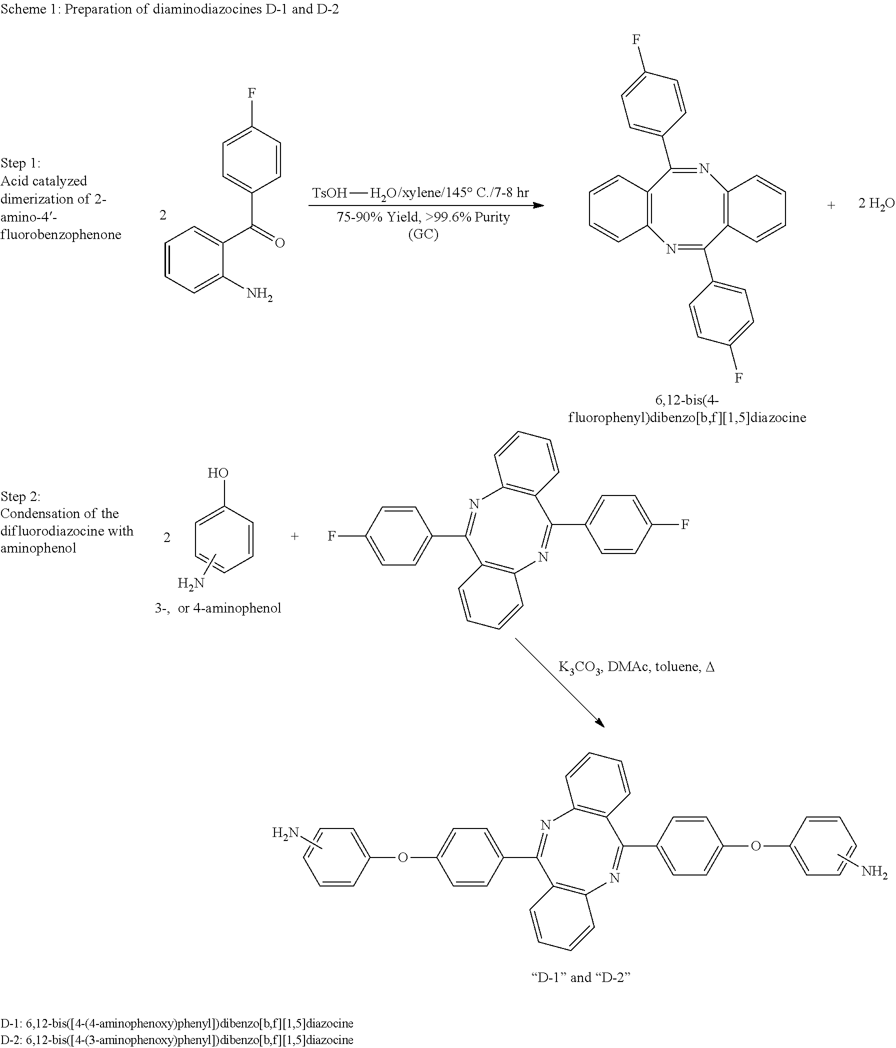

### EXAMPLE 1

### Preparation of 6,12-bis([4-(4-aminophenoxy)phenyl])dibenzo[b,f][1,5]diazocine (D-1)

In a 500 ml three-neck round bottom flask, was placed 20.00 g (0.057 moles) 6,12-bis(4-fluorophenyl)dibenzo[b,f][1,5]diazocine (prepared from acid-catalyzed condensation dimerization of 4′-fluoro-2-aminobenzophenone), 11.62 g (0.1065 moles) 4-aminophenol, 8.82 g (0.0638 moles) potassium carbonate,170 ml dimethylacetamide (DMAc), and 70 ml toluene. The flask was fitted with Dean-Stark trap, condenser and nitrogen inlet/outlet. The mixture was stirred using an overhead mechanical stirrer and heated to reflux (145° C.) using an oil bath. The condensate was collected in the trap and after four hours, the trap drained to increase the reaction temperature to 155° C. for 15 hours. The reaction mixture was cooled to 40° C., filtered through a 2.7 μm glass filter, and the filtrate poured slowly in to a stirring solution of 60 g NaCl in 1 L deionized water. The resulting light brown solid was then isolated by filtration, washed several times with hot water, and then dried at room temperature in a vacuum oven for 12-16 hours. Isolated yield was 22 g (˜76% yield).

LC analysis indicated >98% purity.

IR spectroscopy (ATR): 3428, 3343, 1237, 961, 934 cm⁻¹

### EXAMPLE 2

### Preparation of 6,12-bis([4-(3-aminophenoxy)phenyl])dibenzo[b,f][1,5]diazocine (D-2)

The same as Example 1, except 3-aminophenol was used in place of 4-aminophenol. Obtained 20 g light brown powder with LC purity >98%.

IR spectroscopy (ATR): 3434, 3372, 1221, 957, 933 cm⁻¹

Moreover, it is also possible to prepare diazocines that contain carboxylic acid or anhydride functional groups that could react with a large variety of diamines to form new polyimides, polyamides, or polyamide-imides using the above methods or the well-known methods.

Another embodiment is to convert the carboxylic acids into acid chlorides using SOCl₂ to make them more reactive if needed.

### Synthesis of Polymers

Polyamides or polyimides could be made from these monomers including diacid group (or dianhydride group) with various aliphatic or aromatic diamines, or made from these monomers including acid group (or anhydride group) and amino group.

Polyamide-imides can be made from these monomers including diacid group and/or dianhydride group with various aliphatic or aromatic diamines, or made from these monomers including the combination of acid group, anhydride group and amino group using methods described in the present invention.

### I: Diazocine Polyamides

Poly(dibenzodiazocine amide)s (aka “diazocine polyamides”) were prepared by condensation polymerization of the diazocine diamines with equimolar amounts of either isophthalic or terephthalic acid, as shown below:

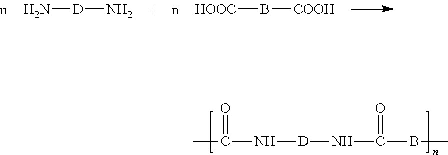

in which the definitions B and D are the same as the above defined.

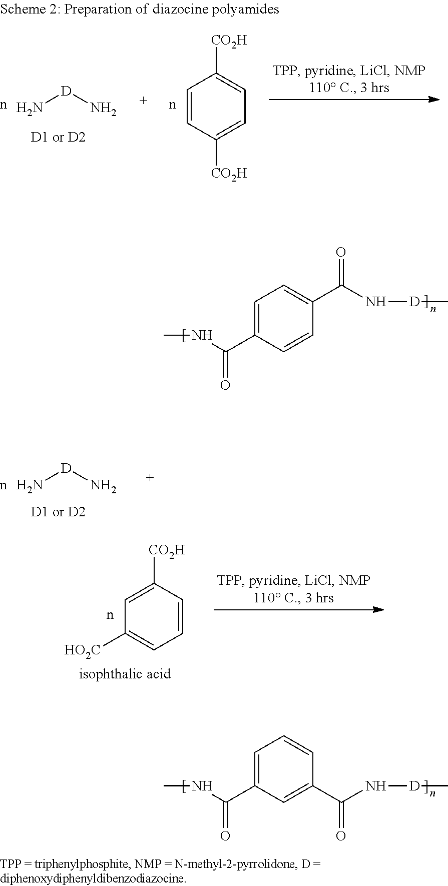

### EXAMPLE 3

In a 2-neck 100 ml oven-dried round bottom flask was placed 0.8 g LiCl, 0.69 g isophthalic acid, 12 ml NMP, 6.3 ml pyridine and 2.1 ml triphenylphosphite. The mixture was stirred at room temperature fo 15 minutes and then 2.20 g (3.9 mmole) D-1 dissolved in 10 ml NMP added. The mixture was stirred and warmed to 110° C. for 3 hours. The mixture was cooled to 40° C. and poured in to 400 ml of a 1:1 v/v mixture of methanol and water. The resulting solid was isolated by filtration and washed several times with warm methanol. The solid was then dried in a vacuum oven for several hours. Infrared analysis of the solid showed the presence of amide C═O and amide N—H groups as well as the diazocine ring system. The average molecular weight of the solid polymer was estimated using GPC (PS standards) and the glass transition temperature (T_{g}) determined using DSC (2^{nd} heat) (Table I).

IR spectroscopy (ATR): 3362, 3061, 1660, 1216, 960, 936 cm⁻¹

### EXAMPLES 4-6

Same as Example 1, except different combinations of D-1 or D-2 diaminodiazocine and isophthalic or terephthalic acid were used as indicated in Table I. All of the polyamides exhibited a single glass transition temperature below 350° C. in the DSC.

IR spectroscopy (ATR) of example 4: 3365, 3062, 1660, 1221, 961, 933 cm⁻¹

IR spectroscopy (ATR) of example 5: 3368, 3054, 1664, 1218, 959, 934 cm⁻¹

IR spectroscopy (ATR) of example 6: 3369, 3062, 1661, 1214, 959, 935 cm⁻¹

TABLE I
Preparation and Properties of Diazocine-Polyamides Prepared
from Aromatic Diacids

| | | | | | T_{g} |
|---|---|---|---|---|---|
| | Diazocine | | GPC | GPC | (° C., |
| Example # | Diamine | Diacid | (M_{w}) | M_{w}/Mₙ | DSC) |
| 3 | D-1 | Isophthalic | 40,800 | 2.26 | 257 |
| 4 | D-1 | Terephthalic | 16,900 | 1.78 | 229 |
| 5 | D-2 | Isophthalic | 28,300 | 2.06 | 261 |
| 6 | D-2 | Terephthalic | 22,200 | 1.97 | 219 |

Aliphatic diacids (e.g., adipic acid) could also be used alone or in combination with the aromatic diacids. Appropriate mixtures of diamines and diacids could be used to adjust the final properties of the polymer. Some examples of diamines that may be used in addition to the diaminodiazocines include, but not restricted to: isomers of diaminodiphenylsulfone (DDS), hexamethylenediamine (HMDA), methylenedianiline (MDA), and isomers of diaminobenzene.

Furthermore, the inventor also found that some similar diazocine polyamides can be obtained by using the above method or the known method of prior art, for example, as follows:

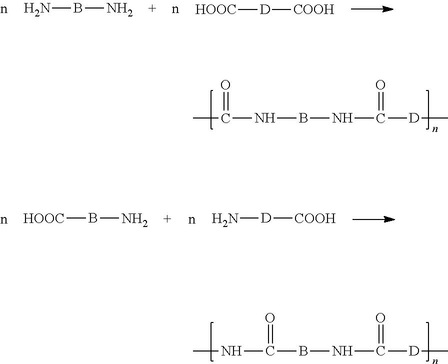

in which the definitions are the same as the above defined.

### II: Diazocine Polyimides

Poly(dibenzodiazocine imide)s (aka “diazocine polyimides”) were prepared by condensation polymerization of the diazocine diamines with equimolar amounts of dianhydride, for example, as shown below:

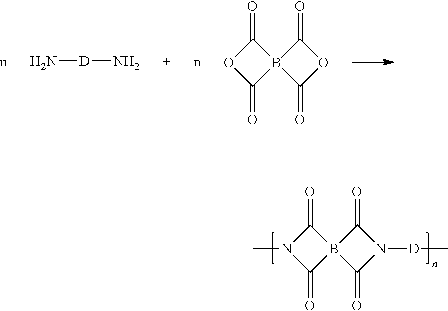

in which the definitions are the same as the above defined.

A two-step method illustrated below in Scheme 3 was used to prepare several new diazocine-polyimides:

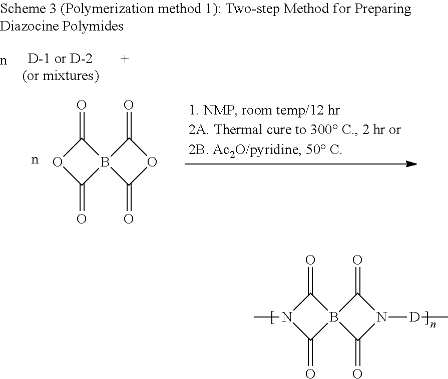

Examples of aromatic dianhydrides include, but are not limited to:

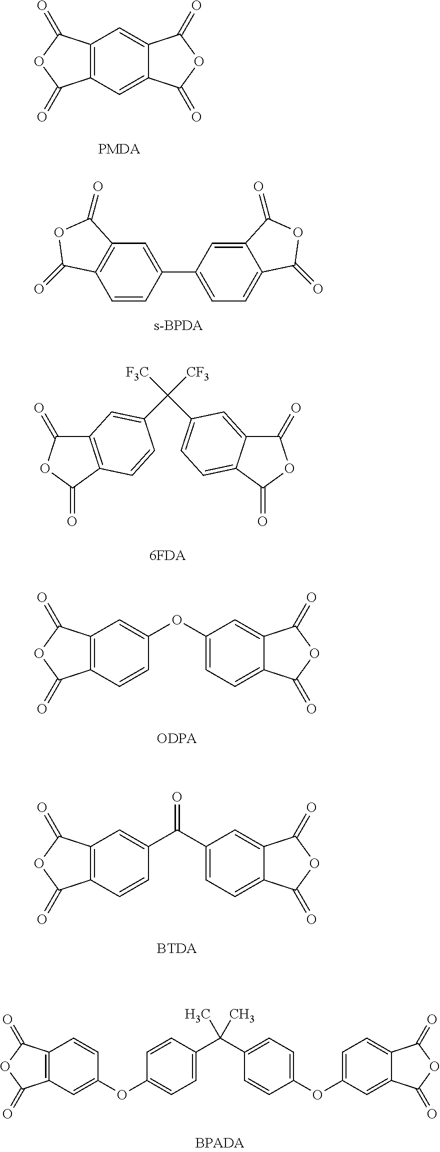

The first step was conducted at room temperature in anhydrous N-methylpyrolidone (NMP). Other suitable solvents include dimethylacetamide (DMAc) and dimethylformamide (DMF). At the end of the first step, the polymer contains a mixture of polyimide and polyamic acid units as shown below:

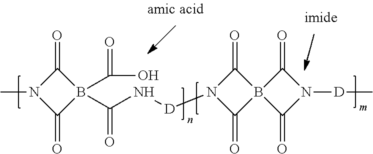

The mixed amic acid/imide is often useful since it is a generally more processable material than the fully imidized polymer. The details are discussed by M. K. Ghosh, K. L. Mittal eds., Polyimides: Fundamentals and Applications, Marcel Dekker, Inc., New York, 1996, the whole content of which is incorporated herein by reference. Also, the amic acid provides a reactive group that can be functionalized with a variety of methods to make polymers for specific applications (e.g., adding silicones, or long chain ethylene oxides).

To prepare the fully imidized polymer, a second step is needed to completely cyclize the amic acid to the imide with loss of an equivalent of water. Two methods were demonstrated: 1) thermal cure (heating to 300° C. for 1-2 hours), and 2) a chemical method (acetic anhydride/pyridine). The details are discussed by N. Yamazaki, M. Matsumoto, F. Higashi in J. Polym. Sci., Polym. Chem. Ed., 13, 1373 (1975), the whole content of which is incorporated herein by reference.

Diazocine polyimides were also made directly in one step at higher temperatures using salicylic acid as the solvent and isoquinoline as a catalyst (Scheme 4). The details are discussed by F. Hasanain, Z. Y. Wang in Polymer, 49, 831-835(2008), the whole content of which is incorporated herein by reference. Other solvents such as m-cresol or benzoic acid (disclosed by A. A. Kuznetsov in High Performance Polymers, 12, 445-460(2000) have been used as the solvent in this one-step method although m-cresol is more toxic and difficult to handle, while benzoic acid tends to give lower molecular weight polymers, which is discussed by V. J. Lee, L-S Wang, U.S. Pat. No. 7,238,771.

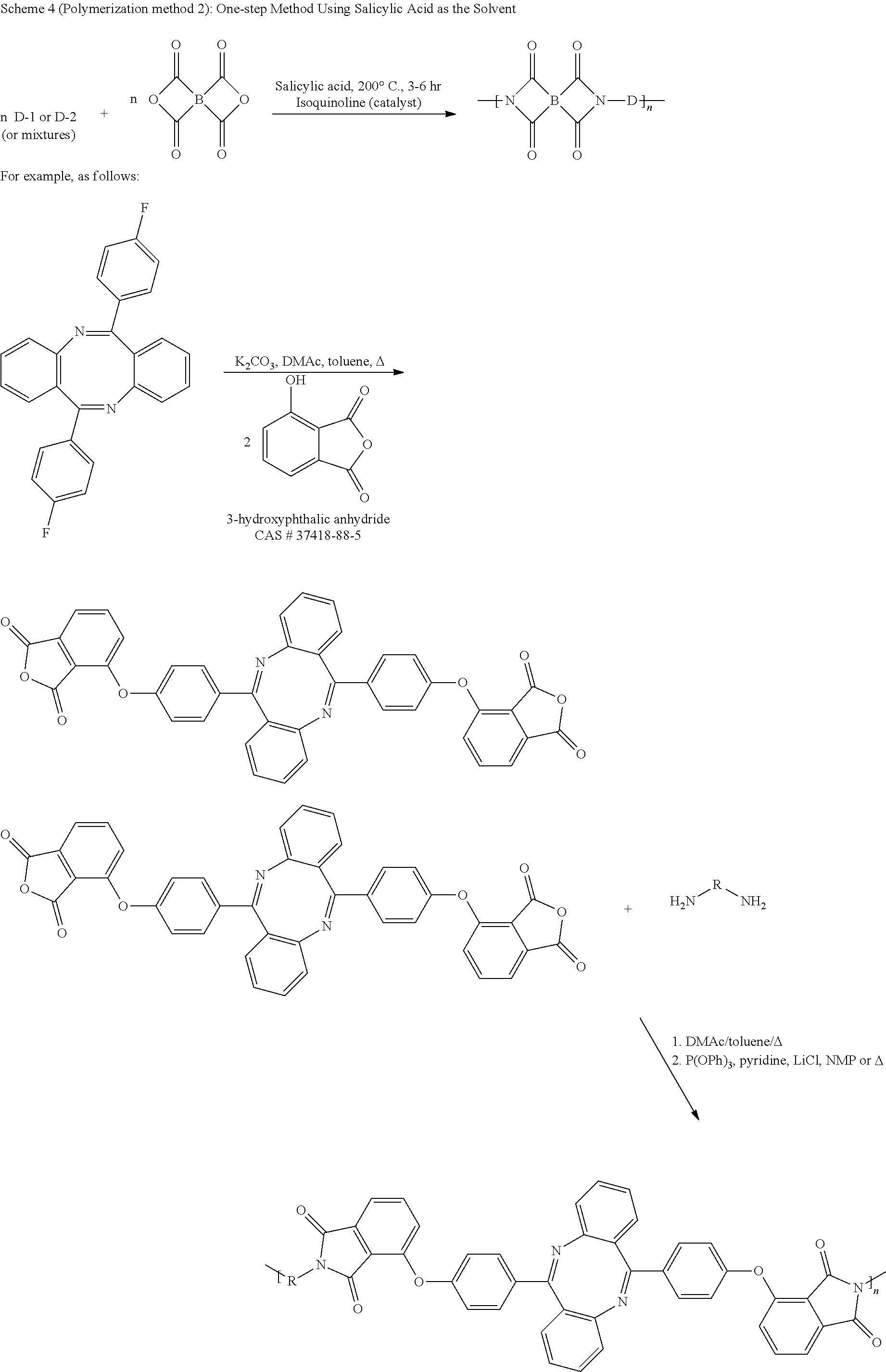

R represents the group B or group D as defined earlier.

A third method, adapted from a recently published report by A. Groth, et al in Australia, uses water as the solvent to form polyimides in one step from tetracarboxylic acids and diamines (Scheme 5). The details are discussed by J. Chiefari, B. Dao, A. M. Groth, J. H. Hodgkin, High Performance Polymers, 18, 31-44(2006), the whole content of which is incorporated herein by reference.

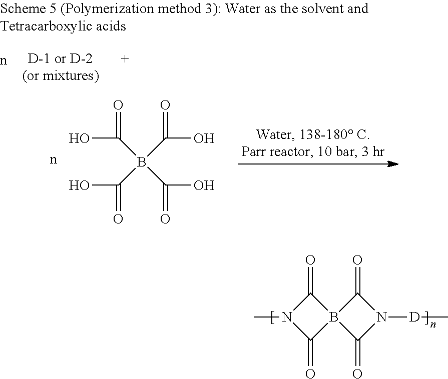

Advantages of this method include using water as the solvent to replace much more expensive and flammable organic solvents as well as the use of the tetracarboxylic acids (TCAs) which are easier to handle than the hygroscopic anhydrides. In this method, the diamine and a TCA or mixture of TCAs are combined in a steel pressure vessel and stirred for several hours under nitrogen pressure at 180° C. Currently, this polymerization method affords low molecular weight polymer; however, the resulting polyimides can serve as reactive oligomers that may be useful as either a component of coatings composites, or as precursors to make block polymers with unique structures and properties.

### EXAMPLE 7

### Preparation of D-2/BTDA Polyimide Using Polymerization Method 1 (Scheme 3) with Heat Cure (Step 2a)

In a dried 100-ml three-neck flask fitted with an overhead stirrer and a nitrogen inlet, was placed 2.00 g (0.00349 moles) of the D-2 diaminodiazocine (example 2) and 15 ml anhydrous NMP. The mixture was stirred at room temperature for 10 minutes to get a clear solution. Next, a solution of 1.13 g (0.00349 moles) BTDA in 10 ml anhydrous NMP was added to the reaction flask and the resulting clear-orange solution stirred at room temperature for 24 hours. The resulting viscous solution was poured on to a glass plate at 100° C. for two hours and then placed in a vacuum oven at 150° C. overnight. The clear, yellow film was then removed from the glass and heated to 200° C. for two hours, and then to 300° C. for an additional two hours. The film was analyzed by FTIR/ATR and found to have typical absorptions associated with polyimides (1781, 1721 cm⁻¹) as well as 959 cm⁻¹ (diazocine), and 1672 cm⁻¹ (benzophenone). Polymer properties are listed in Table II.

### EXAMPLE 8

### Preparation of Polyimide D-1/BTDA

The same procedure as Example 7 except that D-1 diazocine was used. Properties are listed in Table II.

IR spectroscopy (ATR): 1780, 1724, 1237, 960, 931 cm⁻¹

### EXAMPLE 9

### Preparation of Polyimide D-2/PMDA

The same procedure as example 7, except that PMDA was used as the dianhydride. Properties are listed in Table II.

IR spectroscopy (ATR): 1779, 1725, 1236, 960, 931 cm⁻¹

TABLE II
Polyimides made using Method 1 and thermal imidization (2a)

| | Example: | | |
|---|---|---|---|
| | 7 | 8 | 9 |
| Diazocine | D-2 | D-1 | D-2 |
| Dianhydride | BTDA | BTDA | PMDA |
| T_{g} (DSC, ° C.) | 273 | 300 | 278 |
| T_{d-5} (° C.) | 458 | 487 | 439 |
| % char @800° C. | 66 | 65 | 66 |
| Mₙ | 6,118 | 8,763 | 5,231 |
| M_{w} | 16,362 | 28,570 | 12,372 |
| M_{z} | 25,179 | 46,784 | 18,188 |
| M_{w}/Mₙ | 2.67 | 3.26 | 2.37 |

### EXAMPLE 10

### Preparation of D-1/BTDA Polyimide Using Polymerization Method 1 and Chemical Imidization (Step 2b in Scheme 3)

In a 100 ml oven-dried round bottom flask was placed 2.00 g (0.0035 moles) D-2 and 1.13 g (0.0035 moles) BTDA along with 15 ml dry NMP. The mixture was stirred under nitrogen for 16 hours at room temperature. Next, 0.66 ml acetic anhydride and 0.56 ml pyridine were added and the mixture stirred overnight at room temperature. The viscous solution was then poured slowly in to a beaker containing 100 ml methanol with rapid stirring to form a solid. The solid was isolated by filtration and washed several times with fresh methanol. The glass transition temperature was determined using DSC (2^{nd} heat) and the average molecular weight estimated using GPC with polystyrene standards and NMP as the eluant (Table III).

IR spectroscopy (ATR): 1781, 1 722, 1226, 960, 935 cm⁻¹

### EXAMPLES 11-20

### Same as Example 6 Except with Different Combinations of D-1 or D-2 Diazocines and Dianhydrides as Indicated in Table III

IR spectroscopy (ATR) of example 11: 1779, 1725, 1236, 960, 931 cm⁻¹

IR spectroscopy (ATR) of example 12: 1779, 1723, 1226, 960, 931 cm⁻¹

IR spectroscopy (ATR) of example 13: 1776, 1719, 1235, 961 cm⁻¹

IR spectroscopy (ATR) of example 14: 1778, 1723, 1240, 961 cm⁻¹

IR spectroscopy (ATR) of example 15: 1782, 1722, 1231, 959, 923 cm⁻¹

IR spectroscopy (ATR) of example 16: 1779, 1723, 1232, 959 cm⁻¹

IR spectroscopy (ATR) of example 17: 1781, 1719, 1232, 960, 934 cm⁻¹

IR spectroscopy (ATR) of example 18: 1776, 1719, 1239, 960, 934 cm⁻¹

IR spectroscopy (ATR) of example 19: 1778, 1720, 1236, 960 cm⁻¹

IR spectroscopy (ATR) of example 20: 1778, 1723, 1230, 959, 930 cm⁻¹

TABLE III
Characteristics of Diazocine Polyimides Made Using a Chemical
Imidization method in the second step of Method 1.

| | Example: | | | | |
|---|---|---|---|---|---|
| | 10 | 11 | 12 | 13 | 14 |
| Diazocine | D-1 | D-1 | D-1 | D-1 | D-1 |
| Dianhydride | BTDA | PMDA | ODPA | BPDA | BPADA |
| T_{g} (DSC, ° C.) | 300 | 340 | 302 | 338 | 227 |
| M_{w} | 60,030 | n/a* | 68,000 | 96,500 | 18,500 |
| M_{w}/Mₙ | 2.75 | — | 2.97 | 3.14 | 1.74 |

| | Example: | | | | | |
|---|---|---|---|---|---|---|
| | 15 | 16 | 17 | 18 | 19 | 20 |
| Diazocine | D-2 | D-2 | D-2 | D-2 | D-2 | D-2 |
| Dianhydride | BTDA | PMDA | ODPA | BPDA | BPADA | 6FDA |
| T_{g} (DSC, ° C.) | 246 | 293 | 250 | 284 | 260 | 260 |
| M_{w} | 18,900 | 32,200 | 28,500 | 44,600 | 14,900 | 32,300 |
| M_{w}/Mₙ | 2.46 | 2.67 | 2.27 | 2.96 | 1.54 | 2.49 |

*n/a: polymer was insoluble in NMP

### EXAMPLE 21

### Preparation of a Diazocine Polyimide (D-2/BTDA) Using Method 2

In a 38 ml glass pressure tube with PTFE screw cap was placed 3.67 g salicylic acid. The tube was placed in an oil bath at 200° C. for ten minutes to melt the acid. Next, the tube was removed from the oil bath and 1.14 g (0.002 moles) D-2 and 0.644 g (0.002 moles) BTDA were added as solids followed by 8 drops of isoquinoline. The tube was securely sealed with the screw cap, the tube swirled to get a homogeneous solution, and the contents heated in the oil bath for 2 hours. The tube was removed from the oil bath and allowed to cool for 5 minutes. The viscous solution was then poured in to 200 ml methanol to give a fine solid. After filtration, the powder was washed several times with warm water and methanol before drying in a vacuum oven. IR analysis of the solid showed absorptions at 1780 and 1724 cm⁻¹ indicative of imide C═O as well as absorptions at 960 and 931 cm⁻¹ indicative of the dibenzodiazocine ring system. Results of DSC analysis and the inherent viscosity (determined in NMP using an Ubelhode viscometer) are shown in Table IV.

IR spectroscopy (ATR): 1780, 1724, 1230, 960, 931 cm⁻¹

### EXAMPLES 22-23

Same as Example 21 except PMDA (example 22) or 6-FDA (example 23) were used as the dianhydrides. Both polymers had characteristic imide and diazocine absorption bands in IR analysis. The T_{g}'s and inherent viscosities are shown in Table IV.

IR spectroscopy (ATR) of example 22: 1778, 1 722, 1230, 958 cm⁻¹

IR spectroscopy (ATR) of example 23: 1782, 1727, 1230, 962 cm⁻¹

TABLE IV
Diazocine polyimides Made using Method 2 (Salicylic acid as solvent)

| | Example: | | |
|---|---|---|---|
| | 21 | 22 | 23 |
| Diazocine | D-2 | D-2 | D-2 |
| Dianhydride | BTDA | PMDA | 6-FDA |
| T_{g} (DSC, ° C.) | 207 | 234 | 223 |
| IV (dL/g) | 0.14 | 0.095 | 0.096 |

### EXAMPLE 24

### Preparation of D-2/BTDA Polyimide in Water (Polymerization Method 3, Scheme 5)

In a 250 ml round-bottom flask was placed 2.27 g BTDA (0.00524 moles) and 150 ml deionized water and a magnetic stir bar. The mixture was stirred and heated to reflux for one hour to give a clear, pale-yellow solution (tetracarboxylic acid), which was then cooled to 50° C. Next, 3.00 g (0.00524 moles) D-2 diazocine was added slowly to the stirring solution to give an off-white slurry. The mixture was warmed again to reflux for one hour, cooled to 40° C. and then poured in to a 1 L stainless steel Parr reactor. The reactor was sealed and purged with nitrogen using a vacuum/20 psig nitrogen cycle five times. The agitator was controlled at 500 rpm and the reactor heated to 135° C. After maintaining that temperature for one hour, the reactor was then warmed to 180° C. over 14 minutes and maintained at 180° C. for another two hours. The reactor was cooled to 35° C. and the pressure slowly released. The solid was removed from the reactor and dried in an oven for several hours. The solid was ground and washed three times with hot water and three times with methanol on a fritted glass funnel. The solid was then dried in a vacuum oven at 80° C. for 16 hours. Infrared analysis of the powder showed characteristic imide absorptions at 1781 and 1721 cm⁻¹ as well as absorptions at 929 and 949 cm⁻¹ assigned to the diazocine ring. Thermal properties are shown in Table V.

### EXAMPLE 25

### Preparation of D-1/BTDA Polyimide in Water

Same as example 7, except that the D-1 diaminodiazocine was used. FTIR also indicated the presence of imides and an intact diazocine ring. Thermal properties are shown in Table V.

The products were then dried in a vacuum oven at 80° C. for 16 hours. Infrared analysis of the powder showed characteristic imide absorptions at 1781 and 1721 cm⁻¹ as well as absorptions at 929 and 949 cm⁻¹ assigned to the diazocine ring.

TABLE V
Diazocine polyimides made in water:

Example:

| | 24 | 25 |
|---|---|---|
| Diazocine | D-2 | D-1 |
| Dianhydride | BTDA | BTDA |
| T_{g} (DSC, ° C. 2^{nd} heat) | 242 | 235 |
| T_{d-5} (° C.) | 340 | 330 |
| % char @800° C. | 53 | 54 |

Furthermore, the inventor also found that some similar diazocine polyimides can be obtained by using the above method or the known method of prior art, for example, as follows.

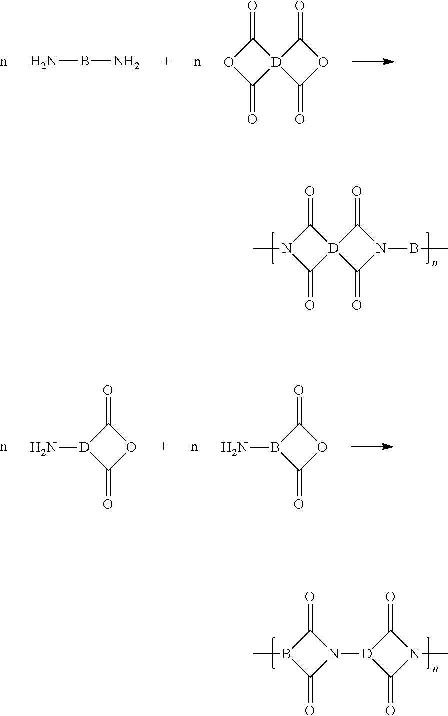

in which the definitions are the same as the above defined.

### III: Diazocine Polyamide-Imides

Poly(amide-imides), such as Torlon®, are made from trimellitic acid derivatives and diamines. Block polyamide-imides (PAIs) incorporating diazocines were prepared by the inventor in two steps: 1) reaction of a diamine with two equivalents of trimellitic anhydride to form a diimide, and 2) reaction with a second diamine using a triphenylphosphite as the catalyst to make the polymer. Some details are discussed by N. Yamazaki, M. Matsumoto, F. Higashi in J. Polym. Sci., Polym. Chem. Ed., 16, 1(1981), the whole content of which is incorporated herein by reference.

Poly(amide-imide)s (aka “diazocine polyamide-imides”) were prepared by condensation polymerization of the diazocine diamines with equimolar amounts of monomer including carboxyl and anhydride group, for example, as shown below:

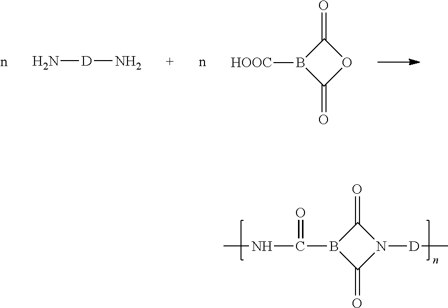

in which the definitions are the same as the above defined.

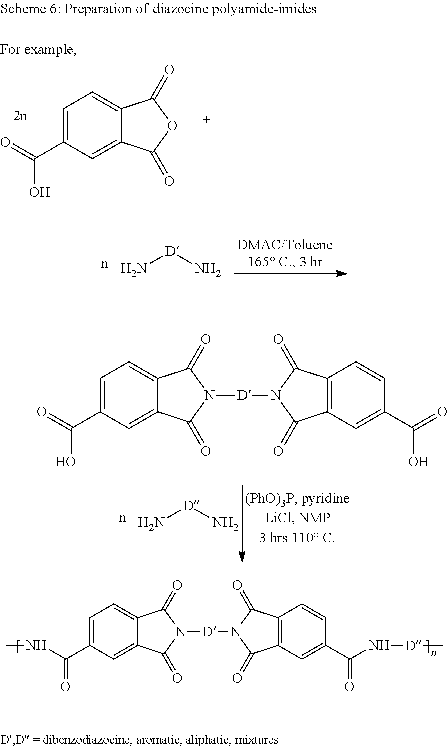

Three examples of polyamide-imides containing the diazocine ring system were prepared. The D-2 diamine was used for all three preparations and DDS (shown below) was used as Diamine A or Diamine B in examples 26 and 28 respectively.

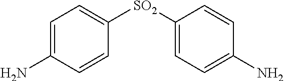

DDS=4,4′-diaminodiphenylsulfone

### EXAMPLE 26

Step 1: In an oven-dried, nitrogen-flushed 250 ml 3-neck round bottom flask, fitted with Dean-Stark trap, condenser, magnetic stir bar, and nitrogen inlet, was placed 15.0 g (0.078 moles) trimellitic anhydride, 9.68 g (0.039 moles) 4,4′-diaminodiphenylsulfone (DDS), and 50 ml dimethylacetamide (DMAc). The mixture was stirred and warmed to 60° C. for 20 minutes to give a clear yellow solution, Next, 25 ml toluene was added and the reaction mixture warmed using an oil bath controlled at 165° C. for three hours while collecting the distillate. The trap was drained and the contents heated for another 30 minutes using an oil bath at 165° C. to remove residual toluene. The mixture was cooled to room temperature and a solid precipitated from the solution. The solid was isolated by filtration, washed several times with methanol and then dried for four hours in a vacuum oven. IR analysis of the solid showed absorptions indicating the presence of imide carbonyls, sulfonyl, and carboxyl OH.
IR spectroscopy (ATR): 3322, 1786, 1721,1678, 1258, 961, 933 cm⁻¹
Step 2: 2.3 g of the dried solid obtained in step 1 (0.0025 moles), 0.5 g LiCl, 1.3 ml TPP, 4 ml pyridine, and 17 ml NMP were mixed vigorously in a 100 ml round bottom flask under nitrogen atmosphere. Next, 0.62 g (0.0025 moles) DDS dissolved in 10 ml NMP was added to the mixture and the contents stirred and heated to 110° C. for 3 hours. The reaction mixture was cooled to room temperature and poured slowly in to 400 ml of a 1/1 v/v mixture of methanol and water with stirring to form a solid. The solid was washed several times with water and methanol and dried in a vacuum oven. Infrared analysis of the solid showed characteristic absorptions due to imide (C═O), amide (C═O), sulfonyl, and the diazocine ring. The average molecular weight of the solid was estimated using GPC with NMP as the eluant and polystyrene standards. The glass transition temperature (T_{g}) was determined using DSC (2^{nd} heat). Results are shown in Table VI.

IR spectroscopy (ATR): 2935, 1784, 1714, 1213, 958, 924 cm⁻¹

### EXAMPLE 27

Same procedure as in Example 26 except the D-2 diazocine was used in both steps. Results are Shown in Table VI.

IR spectroscopy (ATR): 2935, 1784, 1714, 1258, 958, 924 cm⁻¹

### EXAMPLE 28

Same procedure as in Example 26 except the D-2 diazocine was used in the first step and DDS was used as Diamine B. Results are shown in Table VI.

IR spectroscopy (ATR): 3065, 1781, 1718, 1678, 1235, 959, 934 cm⁻¹

TABLE VI
Poly(diazocine amide-imides) prepared

| | | | GPC | GPC | T_{g} |
|---|---|---|---|---|---|
| Ex # | Diamine A | Diamine B | (M_{w}) | M_{w}/Mₙ | (° C., DSC) |
| 26 | DDS | D-2 | 50,900 | 2.55 | 282 |
| 27 | D-2 | D-2 | 48,300 | 2.64 | 284 |
| 28 | D-2 | DDS | 29,490 | 1.97 | 237 |

An alternative method that could be used to make diazocine-containing PAIs is to react D-1 or D-2 alone or as a mixture with other diamines with trimellitic acid chloride (“TMAC”), similar to the method used to make Torlon®. Furthermore, the inventor also found that some similar diazocine polyamide-imides can be obtained by using the above method or the known method of prior art, for example, as follows.

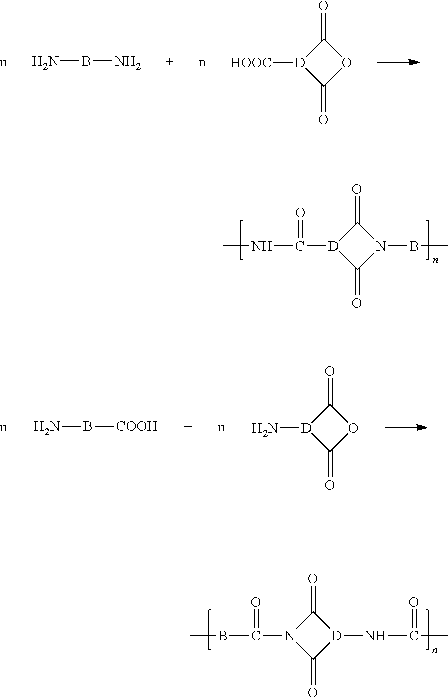

in which the definitions are the same as the above defined.

Should the disclosure of any patents, patent applications, and publications which are incorporated herein by reference conflict with the description of the present application to the extent that it may render a term unclear, the present description shall take precedence.

1- A polymer (P) comprising recurring units (I) of one or more structural formula(e):
-A-B-C-D- (I)
wherein:
A and C, identical or different from each other and from one structural formula to another, independently represent an amido group of formula 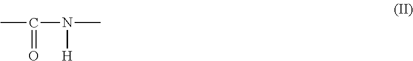
an imido group of formula 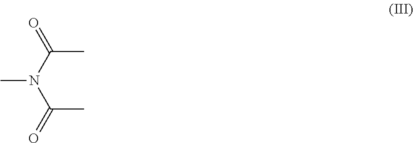
or a mixture thereof,
B, identical or different from one structural formula to another, is independently selected from the set consisting of
C₄-C₅₀ hydrocarbon groups
C₂-C₅₀ groups of the general formulae: 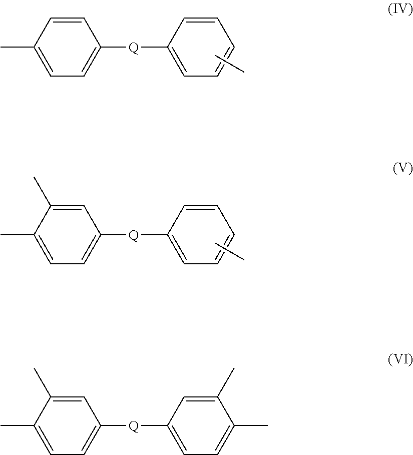
wherein, in formulae (IV) and (V), the unassigned positioned isomer is either meta or para to Q, and Q is a C₀-C₃₈ divalent group containing at least one heteroatom,
a dibenzodiazocine-containing divalent group,
and a mixture thereof,
D, identical or different from one structural formula to another, independently represents a dibenzodiazocine-containing divalent group.

2- The polymer (P) according claim 1, wherein the recurring units (I) are of at least one structural formula(e):

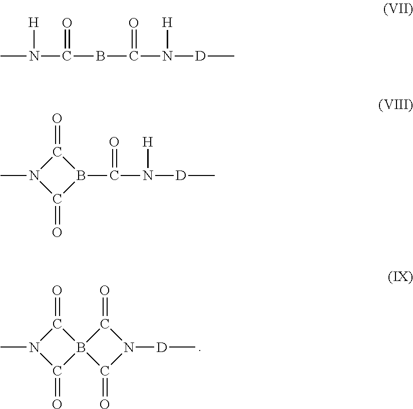

3- The polymer (P) according to claim 1, wherein the recurring units are a mixture of recurring units of at least two structural formulae -A-B-C-D.

4- The polymer (P) according to claim 1, wherein said C₄-C₅₀ hydrocarbon groups are arylenes, trivalent groups of aromatic hydrocarbons or tetravalent groups of aromatic hydrocarbons.

5- The polymer (P) according to claim 1, wherein said C₁₂-C₅₀ groups are selected from the group consisting of

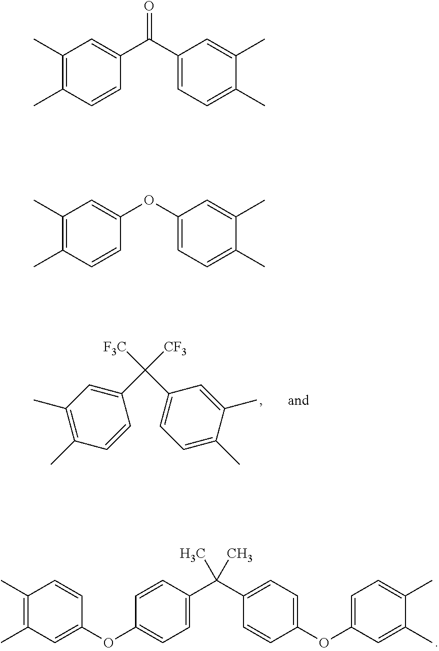

6- The polymer (P) according to claim 1, wherein said dibenzodiazocine-containing divalent group(s) in B or D is(are) selected from the following groups consisting of: 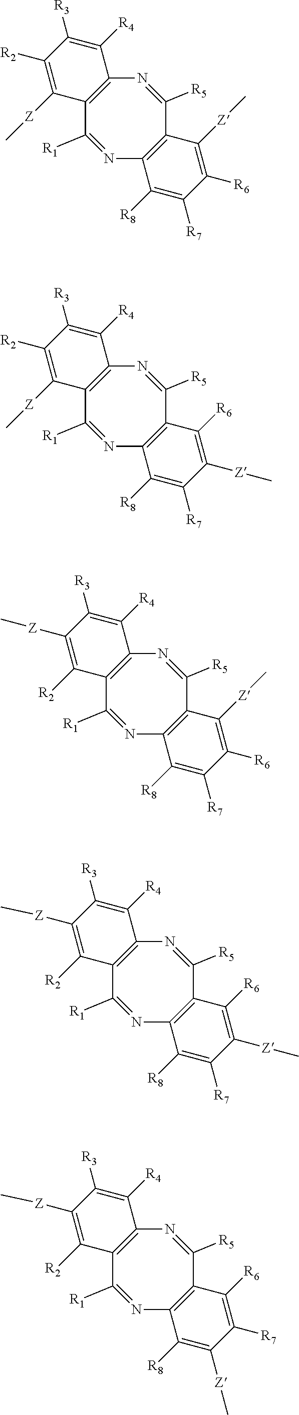 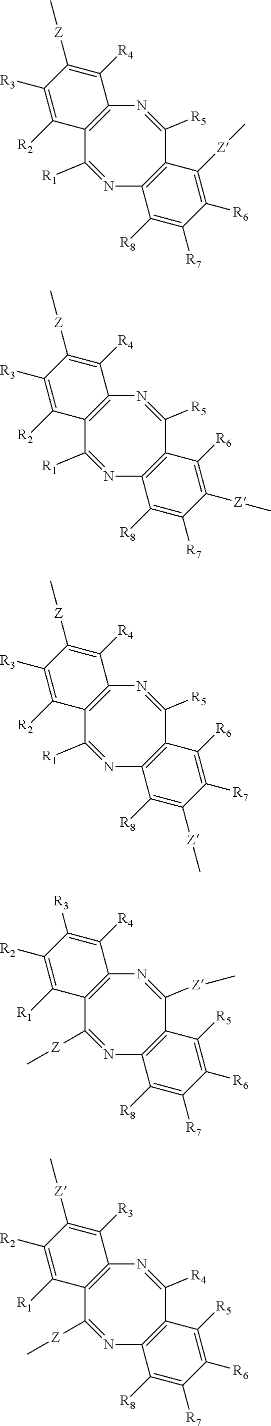 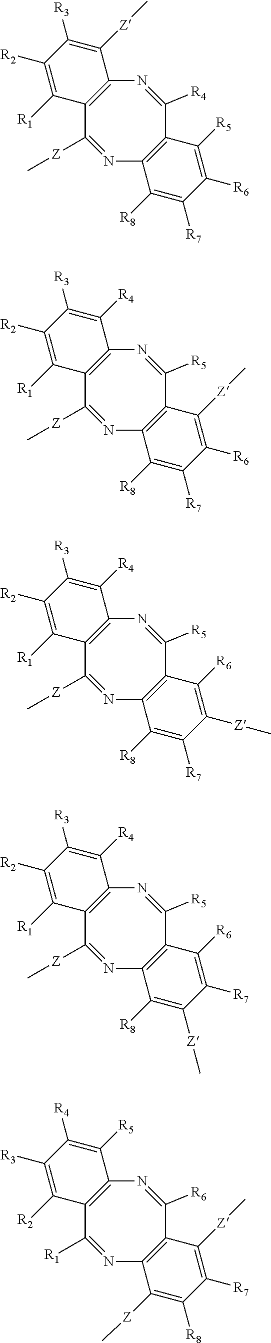 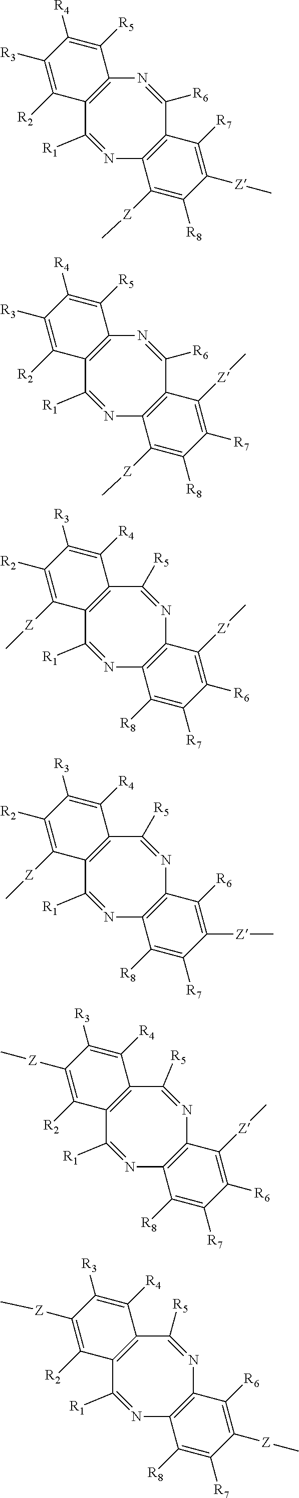 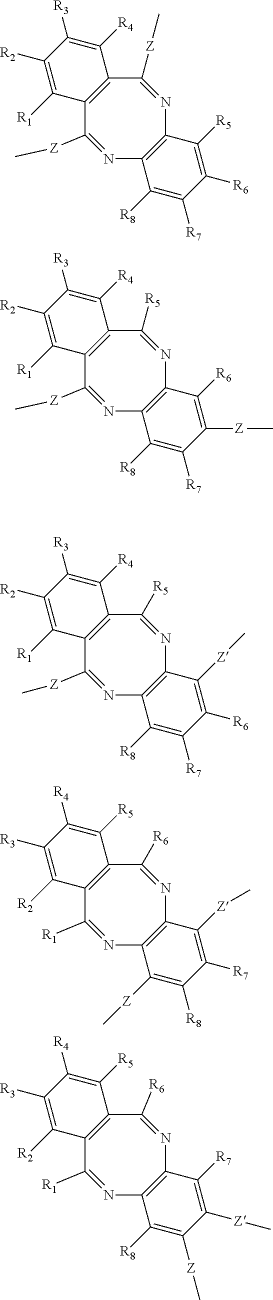 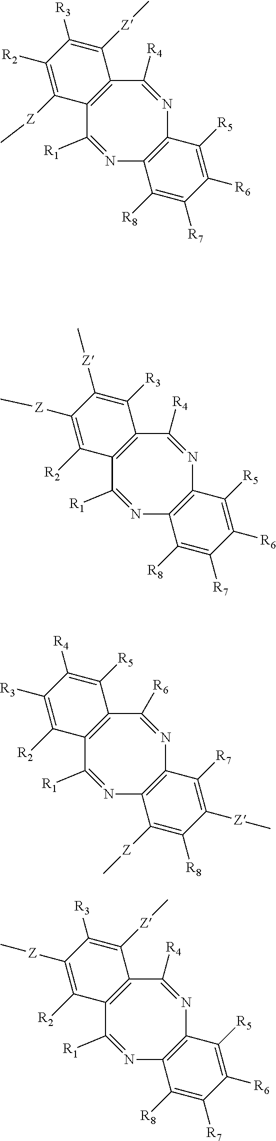
and mixtures thereof,
wherein:
R₁-R₈ are independently selected from the group consisting of H, alkyl, substituted alkyl, aryl, substituted aryl, heteroaryl, substituted heteroaryl, halogen, —CN, —CHO, —CORₐ, —CRₐ═NR_{b}, —ORₐ, —SRₐ, —SO₂Rₐ, —PORₐR_{b}, —PO₃Rₐ, —OCORₐ, —CO₂Rₐ, —NRₐR_{b}, —N═CRₐR_{b}, —NRₐCOR_{b}, and —CONRₐR_{b} in which Rₐ and R_{b} are independently selected from the group consisting of H, alkyl, substituted alkyl, aryl, substituted aryl, heteroaryl, and substituted heteroaryl, and two or more of R₁-R₈, Rₐ, and R_{b} may or may not be linked to form a ring structure,
Z and Z′, independently represent unsubstituted or substituted divalent group, a direct bond or a mixture thereof.

7- The polymer (P) according to claim 1, wherein the B and/or D is of the following formula: 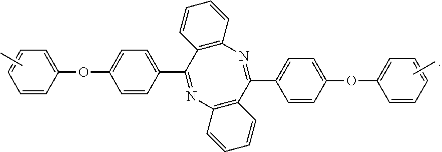
wherein, the unassigned positioned isomer is either meta or para to O.

8- The polymer (P) according to claim 1, wherein the molecular weight of said polymer is more than 5×10³, and lower than 1000×10³.

9- A method for preparing a the polymer according to claim 1, comprises reacting in a polycondensation reaction at least one set of the following four sets of monomers (S1), (S2), (S3) and (S4):
Set (S1)
at least one monomer (M1) of general formula X-D-X, and
at least one monomer (M2) of general formula Y—B—Y,
Set (S2)
at least one monomer (M3) of general formula X—B—X, and
at least one monomer (M4) of general formula Y-D-Y,
Set (S3)
the monomers X-D-Y (M5) and X—B—Y (M6),
Set (S4)
X-D-Y (M5)
wherein:
B, identical or different from one structural formula to another, is independently selected from the set consisting of
C₄-C₅₀ hydrocarbon groups
C₁₂-C₅₀ groups of the general formulae: 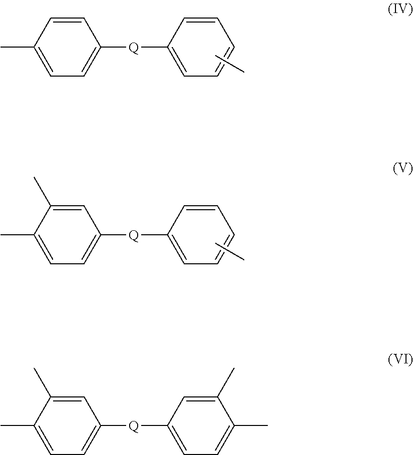
wherein, in formulae (IV) and (V), the unassigned positioned isomer is either meta or para to Q, and Q is a C₀-C₃₈ divalent group containing at least one heteroatom,
a dibenzodiazocine-containing divalent group,
and a mixture thereof,
D, identical or different from one structural formula to another, independently represents a dibenzodiazocine-containing divalent group,
X independently represents amino,
Y, identical or different from each other and from one monomer to another, independently represents carboxyl or anhydride group, or a mixture thereof.

10- The method according to claim 9, wherein Y—B(or D)-Y and X—B(or D)-Y are as follows:

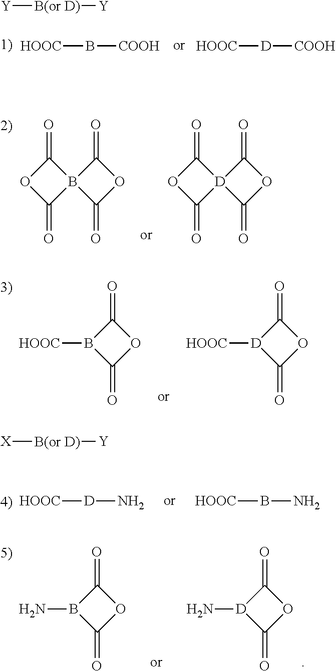

11- Polymer compositions containing at least one said polymers (P) according to claim 1.

12- Shaped articles or shaped parts of article containing at least one said polymer composition according to claim 11.

13- A monomer having a general formula: G-D-G, in which, D represents a dibenzodiazocine-containing divalent group, selected from the group consisting of: 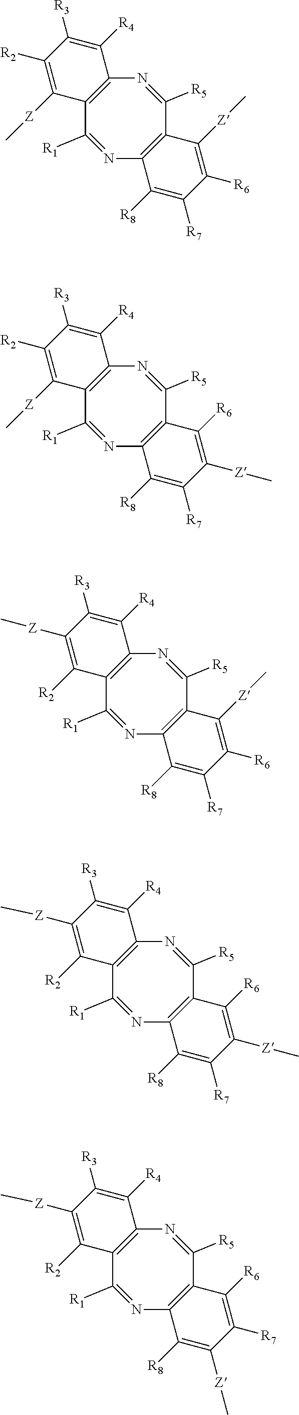 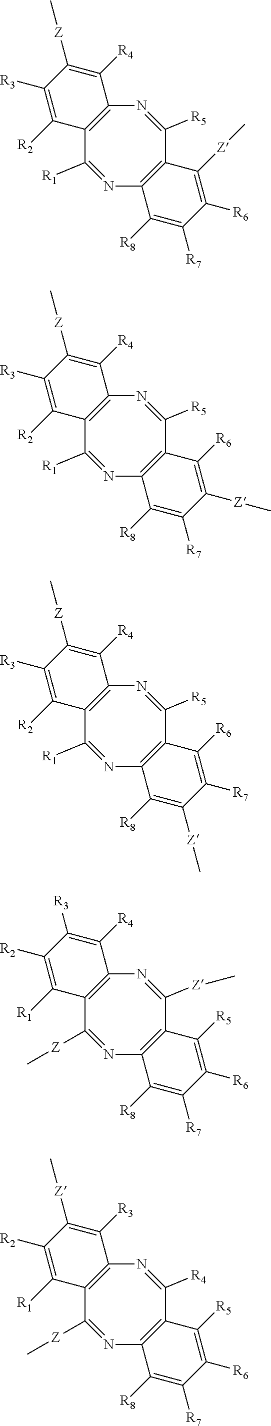 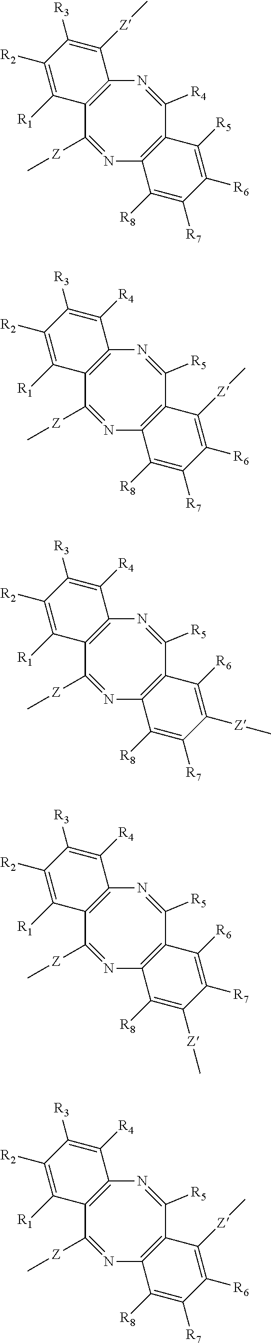 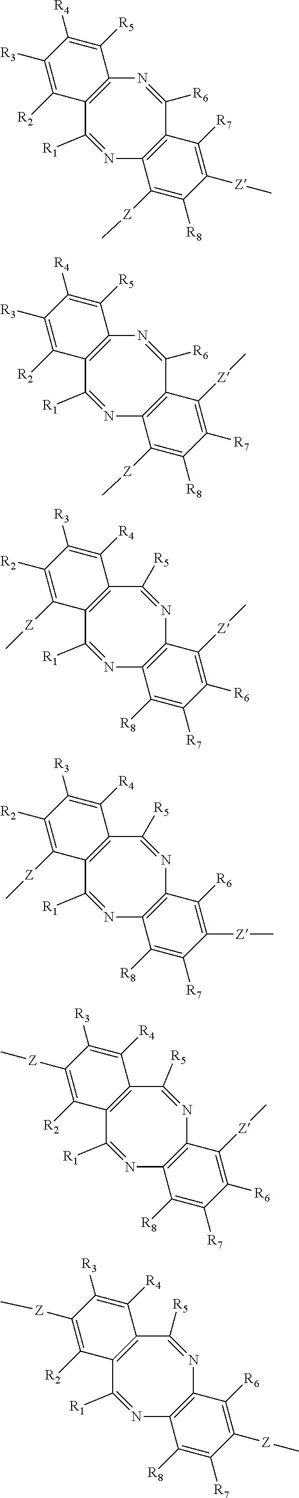 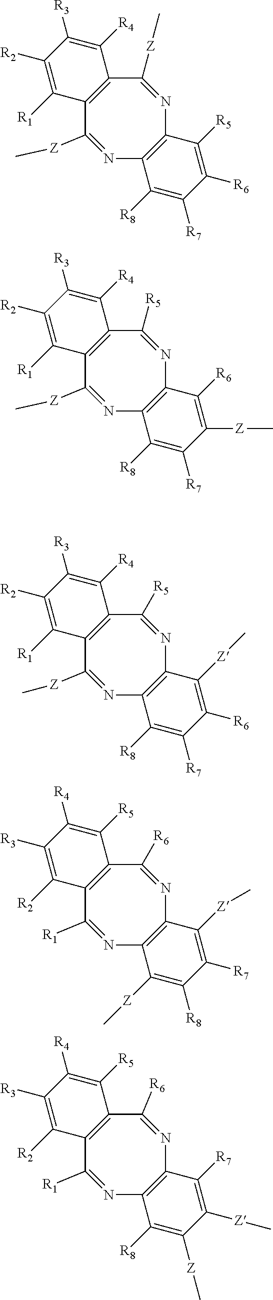 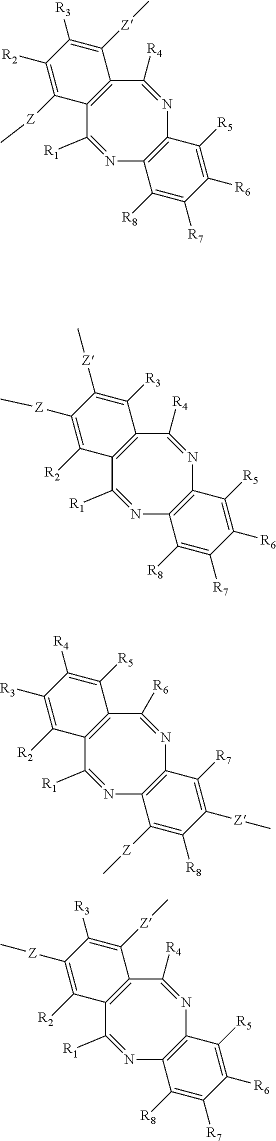
wherein:
R₁—R₈ are independently selected from the group consisting of H, alkyl, substituted alkyl, aryl, substituted aryl, heteroaryl, substituted heteroaryl, halogen, —CN, —CHO, —CORₐ, —CRₐ═NR_{b}, —ORₐ, —SRₐ, —SO₂Rₐ, —PORₐR_{b}, —PO₃Rₐ, —OCORₐ, —CO₂Rₐ, —NRₐR_{b}, —N═CRₐR_{b}, —NRₐCOR_{b}, —RₐOR_{b}, —CONRₐR_{b} in which Rₐ and R_{b} are independently selected from the group consisting of H, alkyl, substituted alkyl, aryl, substituted aryl, heteroaryl, and substituted heteroaryl, and two or more of R₁—R₈, Rₐ, and R_{b} may or may not be linked to form a ring structure,
Z and Z′, independently represent unsubstituted divalent group, substituted divalent group, or a direct bond,
G, identical or different from each other, independently represents reactive radical chosen from the group consisting of hydroxyl, halogen, carboxyl, nitro, amino, anhydride group,
with the condition that: when G represents hydroxyl, halogen or nitro, Z and Z′, identical or different from each other, represent aryleneoxyarylene.

14. A method for preparing a polymer which comprises polymerizing the monomer according to claim 13.

15. A polymer prepared by the method according to claim 14.

16. Shaped articles or shaped parts of article containing at least one said polymer (P) according to claim 1.

17. A polymer prepared by the method according to claim 9.
